(19) United States
(12) Patent Application Publication
(10) Pub. No.: US 2026/0366860 A1
(43) Pub. Date: Nov. 19, 2026

(54) SHAPE MEASURING APPARATUS

(71) Applicant: MITUTOYO CORPORATION, Kanagawa (JP)

(72) Inventors: Kazuya IBI, Hiroshima (JP); Yoshiyuki OMORI, Hiroshima (JP); Hiiro SONE, Kanagawa (JP); Masayuki NARA, Ibaraki (JP); Hiroki UJIHARA, Kanagawa (JP)

(73) Assignee: MITUTOYO CORPORATION, Kanagawa (JP)

(21) Appl. No.: 19/663,479

(22) Filed: Apr. 30, 2026

(30) Foreign Application Priority Data
May 2, 2025 (JP) 2025-077012
Mar. 4, 2026 (JP) 2026-034739

(51) Int. Cl. G01B 11/00

(52) U.S. Cl. CPC G01B 11/007

(57) ABSTRACT

There is provided a calibration method that excels in both calibration accuracy and time efficiency, as a calibration method for a shape measuring apparatus including a rotary mechanism. A calibration jig having a spherical portion with a known diameter is placed on a workpiece holding stage. Calibration measurement data is acquired by a measuring head measuring the spherical portion while a rotary mechanism rotates the measuring head relative to the calibration jig. A shape measuring apparatus is calibrated in such a manner that a fitted sphere obtained by fitting the calibration measurement data to a spherical equation approximates the spherical portion.

### INCORPORATION BY REFERENCE

This application is based upon and claims the benefit of priority from Japanese patent application No. 2025-077012, filed on May 2, 2025, and Japanese patent application No. 2026-034739, filed on Mar. 4, 2026, the disclosures of which are incorporated herein in their entirety by reference.

### BACKGROUND

### 1. Field

The present disclosure relates to a shape measuring apparatus.

### 2. Description of the Related Art

Roundness measuring apparatuses are known as shape measuring apparatuses. A roundness measuring apparatus includes a rotary mechanism and is capable of accurately measuring changes in the outside or inside diameter of a cylindrical or tube-shaped workpiece. In addition, it has been proposed that the shape of a workpiece that is circular or spherical as a whole, or a workpiece with a partially curved surface is measured with high precision and efficiency by effectively utilizing the rotary mechanism of the roundness measuring apparatus. For example, there is a need to measure the shapes of gears, aspheric lenses, or free-form lenses.

In a measurement operation of a roundness measuring apparatus, while its rotary mechanism rotates a workpiece, a stylus is brought into contact with the surface of a workpiece in order for the stylus to scan the surface. The changes (displacements) in the position and posture of the stylus at this time are detected using multiple detectors, and the shape of the workpiece is determined from the detected position and posture of the stylus. Naturally, the multiple detectors cannot directly detect the contact point between the workpiece and the stylus. The contact point between the workpiece and the stylus is determined by calculations (a type of forward kinematic solution) that take into account the detection values of the multiple detectors, the geometry of the stylus, the relative positions of the stylus, the rotation axis, and the detectors, and the detection sensitivity (detection gain) of each detector. In order to obtain accurate measurement values by the roundness measuring apparatus, it is essential that the parameters in the transformation formulae, which transforms the detection values of the detectors into the contact point between the workpiece and the stylus, are accurate.

Furthermore, a characteristic feature of a roundness measuring apparatus is that the coordinate data obtained by the roundness measuring apparatus is based on the rotation axis of its rotary mechanism as the reference (origin). Therefore, the workpiece must be accurately centered as a preparation before measurement. However, above all, it is of the utmost importance that the origin of the measuring coordinate system of the roundness measuring apparatus is accurately set on the rotation axis.

For example, in FIG. 1, the stage of the rotary table rotates about the rotation center axis as its rotation center. The rotation center axis is mechanically fixed. When the origin of a measurement coordinate system Σ_{RT} is represented as ORT, the measurement coordinate system Σ_{RT} is moved and adjusted in such a manner that the offset between the origin ORT and the rotation axis is zero. Then, assuming that the forward/backward movement direction of a probe 350 is along the forward/backward movement direction of an X-arm 330 (on an X-axis), the measurement data is provided as polar coordinates based on a distance ρ from the origin ORT and a rotation angle θ of the rotary table, or as cylindrical coordinates (ρ, θ, z) that additionally include a height z.

### SUMMARY

Various jigs and methods for calibrating the parameters of roundness measuring apparatuses have been proposed.

However, the calibration jigs or methods that have been proposed for roundness measuring apparatuses are fundamentally limited to calibrating one parameter (or one type of parameter). For example, in a conventional technique, the origin can be calibrated using a calibration sphere, but separate calibration operations using different calibration jigs are required for other parameters. In a conventional technique, a single calibration jig is configured by integrating a calibration sphere for origin calibration with a jig (flat surface) for gain calibration. However, in practice, gain calibration must still be performed as a separate calibration operation different from origin calibration. Performing multiple types of labor-intensive calibration operations each time a workpiece is exchanged or the posture of a stylus is changed is inefficient in terms of time.

In addition, there have been limitations regarding calibration accuracy. In a conventional technique, a calibration sphere placed on a rotary table is centered, and then the vertex of the centered calibration sphere is searched for. Specifically, when the top or bottom surface of the calibration sphere is scanned, the point indicating the highest point (maximum value in the Z direction) or the lowest point (minimum value in the Z direction) is assumed to be on the rotation axis and is set as the origin. With this method, the accuracy of origin calibration is affected by both the accuracy of centering and the accuracy of vertex search. Then, achieving perfect centering is difficult, and an error of approximately 0.x micrometers inevitably remains. However, this level of origin shift would not have been a significant issue given the measurement accuracy required for conventional roundness measurements. For example, if the roundness of simple cylinders or cylindrical shapes is evaluated as in the past, this level of measurement accuracy would have been considered sufficient. However, considering the need to evaluate the geometric tolerances of recently accuracy-machined workpieces (such as micro-gears), aspheric lenses, and free-form lenses (optical components), further improvements in accuracy are desired.

One aspect of the present disclosure is to provide a shape measuring apparatus, which includes a rotary mechanism, capable of performing calibration with superior accuracy and time efficiency.

A shape measuring apparatus according to an exemplary embodiment of the disclosure, including:
a measuring unit that measures at least one point on a surface of an object to be measured;
a workpiece holding stage that holds the object to be measured; and
a rotary mechanism that rotates the workpiece holding stage relative to the measuring unit about a predetermined axis as a rotation center axis to rotationally move the measuring unit relative to the object to be measured, in which
the shape measuring apparatus is configured to perform:
a calibration data acquisition step of acquiring calibration measurement data by the measuring unit measuring a calibration jig with a known shape while the rotary mechanism rotates the measuring unit relative to the calibration jig; and
a calibration calculation step of calibrating the shape measuring apparatus in such a manner that the calibration measurement data acquired in the calibration data acquisition step approximates the known shape of the calibration jig.

### BRIEF DESCRIPTION OF THE DRAWINGS

FIG. 1 is a diagram showing an origin offset parameter;

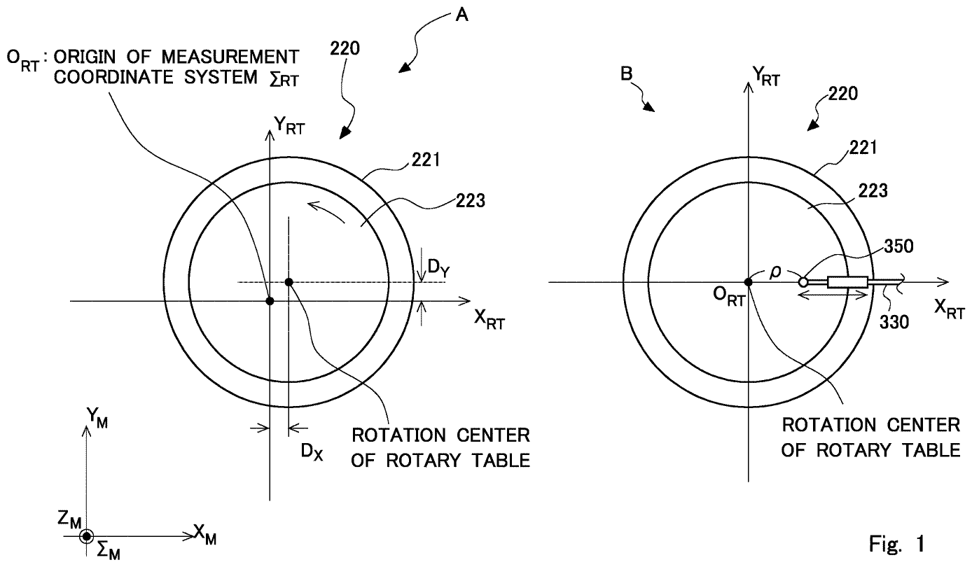

FIG. 2 is an exterior view of a roundness measuring apparatus;

FIG. 3 is a diagram showing an example of a vertical posture;

FIG. 4 is a diagram showing an example of a horizontal posture;

FIG. 5 is a diagram showing examples of various measurement modes;

FIG. 6 is a perspective view of a stylus;

FIG. 7 is a side view of the stylus;

FIG. 8 is a diagram showing an assembly error of a stylus edge part;

FIG. 9 is a diagram showing an assembly error of a stylus arm part;

FIG. 10 is a diagram showing an example of a calibration jig;

FIG. 11 is a diagram showing an example of the calibration jig;

FIG. 12 is a flowchart showing a procedure of a calibration method;

FIG. 13 is a diagram showing, as an example, that the calibration jig is set on a rotary table;

FIG. 14 is a diagram showing g, as an example, that the calibration jig is set on the rotary table;

FIG. 15 is a diagram showing an example of the stylus in contact with a reference sphere;

FIG. 16 is a diagram showing an example of the stylus in contact with the reference sphere;

FIGS. 17A and 17B are diagrams showing an example of the rotation of the reference sphere and the displacement of the stylus edge part;

FIG. 18 is a diagram showing an example of the rotation of the reference sphere and the displacement of the stylus edge part;

FIG. 19 is a diagram showing an example of a shift between the intended contact point and the actual point of contact;

FIGS. 20A to 20C are diagrams for explaining the experimental method;

FIG. 21 is a diagram showing the experimental results;

FIG. 22 is a diagram showing the experimental results;

FIG. 23 is a diagram showing an example of a shape measuring apparatus to be calibrated in a second exemplary embodiment;

FIG. 24 is a conceptual diagram showing a sensor coordinate system Σ_{S} as an example;

FIG. 25 is a flowchart showing a procedure of a calibration method in the second exemplary embodiment; and

FIG. 26 is a diagram showing a configuration example, as a modification of the shape measuring apparatus, in which a rotary mechanism rotationally move a sensor around a workpiece.

### DETAILED DESCRIPTION

Embodiments of the disclosure are illustrated and described with reference to the reference signs assigned to the elements in the drawings. Note that each embodiment (example) may be implemented independently, or two or more embodiments (examples) may be implemented in combination, and examples of modifications added in each embodiment (example) are applicable to other embodiments.

### First Exemplary Embodiment

The disclosure relates to a calibration method for a roundness measuring apparatus. As a premise, a configuration of the roundness measuring apparatus will be briefly explained. However, the calibration method described herein is broadly applicable to a shape measuring apparatus including a rotary mechanism, and the example (roundness measuring apparatus) described below is merely an example and should not be limited to this configuration.

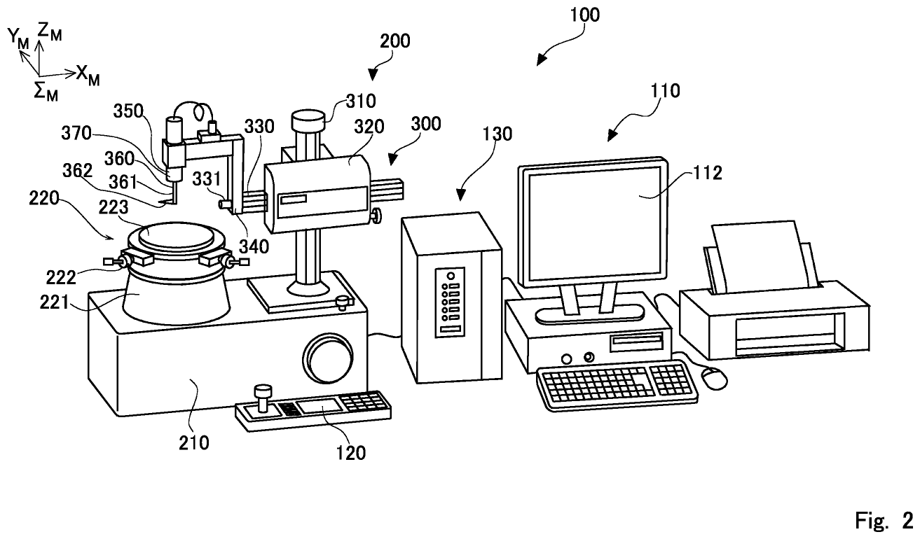

FIG. 2 is an external view of a roundness measuring apparatus 100. In the drawing, an X_{M} axis, a Y_{M} axis, and a Z_{M} axis of a machine coordinate system Σ_{M} are shown. The X_{M} axis runs from left to right on the sheet, the YM axis runs from front to back, and the Z_{M} axis runs from bottom to top.

The roundness measuring apparatus 100 includes a measuring machine main body 200, a host computer 110, an operation unit 120, and a motion controller 130.

The measuring machine main body 200 includes a base 210, a rotary table 220, and a coordinate measuring unit 300.

The rotary table 220 includes a rotary drive unit (rotary mechanism) 221 and a stage (workpiece holding stage) 223. The rotary drive unit 221 is installed on the base 210 and rotates the disc-shaped stage 223. The rotary drive unit 221 is rotationally driven by control signals from the motion controller 130, and a rotation angle θ is detected by a built-in rotation detector (for example, a rotary encoder).

Here, it is assumed that the rotary drive unit 221 is provided in such a manner that the rotation axis of the rotary drive unit 221 is parallel to the Z_{M} axis. In addition, it is assumed that, as the roundness measuring apparatus 100, the axial accuracy (rotational accuracy) of the rotation axis of the rotary drive unit 221 is adjusted with extremely high precision.

On the side surface of the rotary drive unit 221, adjustment knobs 222 are disposed. The adjustment knobs 222 are disposed, for example, at 90-degree intervals in the circumferential direction. Two of the knobs are for translational adjustment (centering), and the remaining two are for tilt adjustment (leveling). By operating the adjustment knobs 222, the position and posture of the stage 223 can be adjusted, thereby enabling the centering and leveling of a workpiece placed on the stage 223. The adjustment knobs 222 can be operated manually or by motor drive. That is, the adjustment knobs 222 are electrically driven by control signals from the motion controller 130.

The coordinate measuring unit 300 includes a Z-axis column 310, a Z-slider 320, an X-arm 330, a head holder 340, and a probe (measuring head) 350.

The Z-axis column 310 is provided on the base 210 in a standing manner, so as to be parallel to the Z_{M} axis. The Z-slider 320 is provided on the Z-axis column 310 so as to be movable in the height direction (Z_{M} direction). A height position Zm (Z_{M}-direction position) of the Z-slider 320 is detected by a Z_{M}-direction position detector (Z_{M}-direction encoder).

The X-arm 330 is supported by the Z-slider 320 so as to be movable in the X_{M} direction. An X_{M}-direction position Xm of the X-arm 330 is detected by an X_{M}-direction position detector (X_{M}-direction encoder).

The head holder 340 is an L-shaped member, the base end of the head holder 340 is attached to the tip end of the X-arm 330, and the probe 350 is attached to the tip end of the head holder 340.

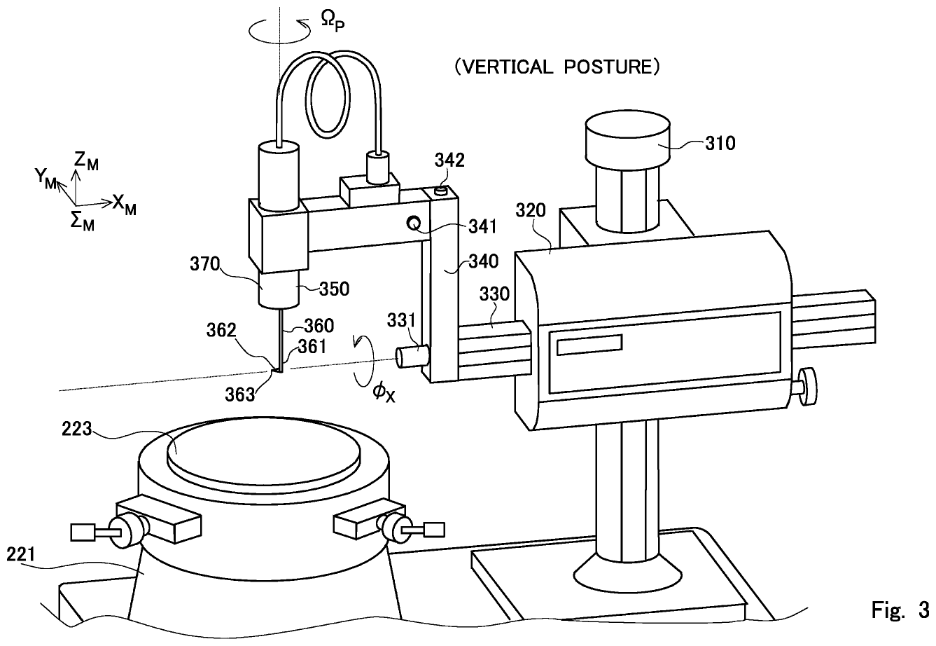

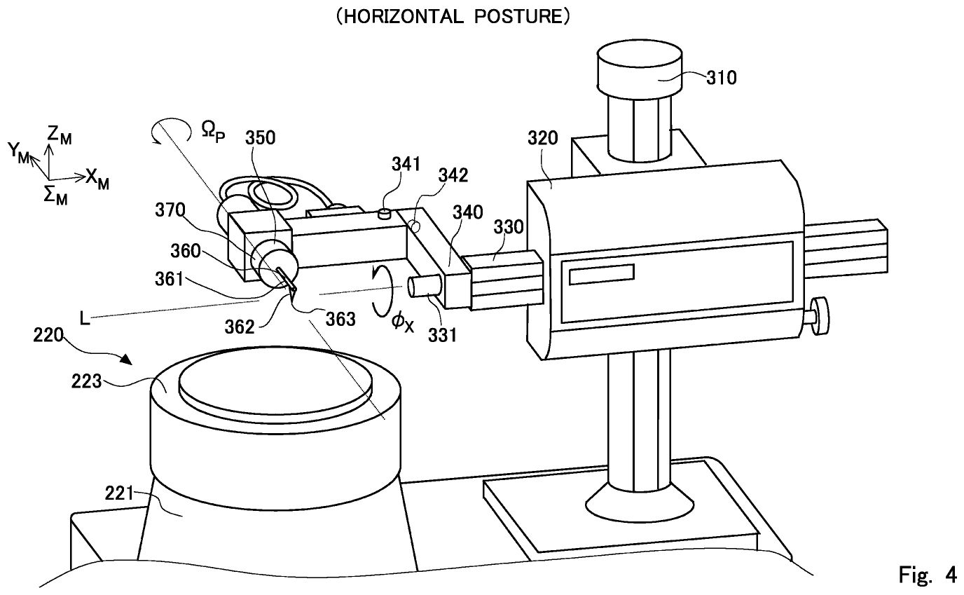

The base end of the head holder 340 is provided so as to be rotatable about a rotation axis 331 extending in the X_{M}-axis direction. The range of rotation is, for example, from 0° to −90°. As shown in FIG. 3, when the head holder 340 is vertical (or when the rotation angle Φ_{X} of the head holder 340 is 0°), this is referred to as a “vertical posture”. As shown in FIG. 4, when the head holder 340 is horizontal (or when the rotation angle Φ_{X} of the head holder 340 is −90°), this is referred to as a “horizontal posture”. The rotation angle Φ_{X} (tilt angle) of the head holder 340 is detected by a holder rotation angle detector (for example, a rotary encoder). However, the rotation angle Φ_{X} (tilt angle) of the head holder 340 may be mechanically limited to either 0° or −90° to omit the holder rotation angle detector.

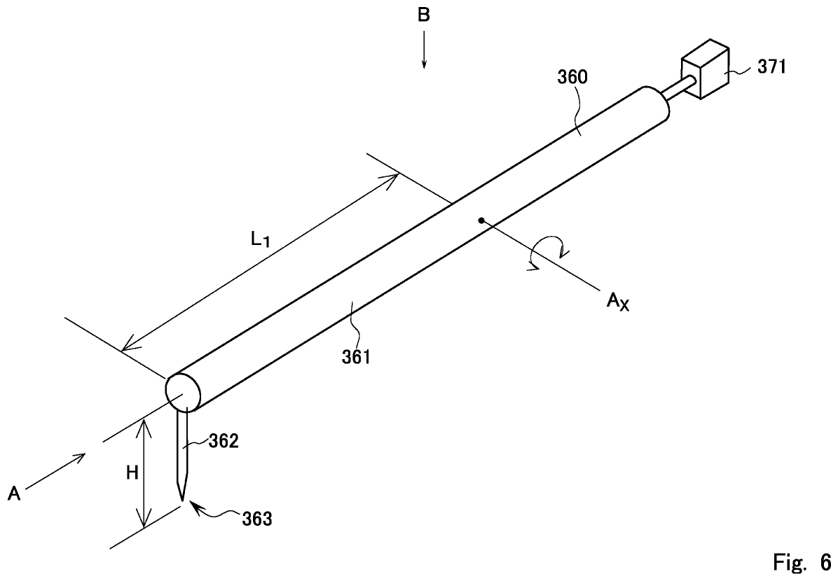

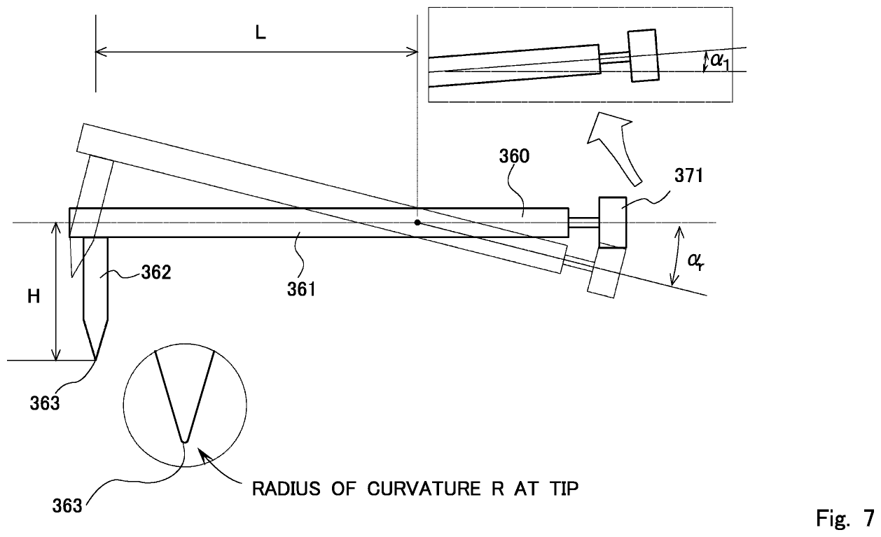

The probe 350 is a lever-type electrical micrometer and is attached to the tip end of the head holder 340. The probe 350 includes a stylus 360 and a probe body part 370. As shown in FIGS. 6 and 7, the stylus 360 includes a stylus arm part 361 and a stylus edge part 362. The stylus arm part 361 is a rod-shaped body of a predetermined length. The stylus arm part 361 is supported at its base end by the probe body part 370 so as to be tiltable. At the tip end of the stylus arm part 361, the stylus edge part 362 is provided perpendicular to the stylus arm part 361. The tip end of the stylus edge part 362 is a contact point 363 that is brought into contact with a workpiece and is finished with a radius of curvature R.

Here, it is assumed that the probe body part 370 rotatably supports the base end of the stylus 360 so as to allow the stylus 360 to tilt in only one direction (that is, a lever mechanism). A tilt angle αr of the stylus 360 is detected by a tilt angle detector (for example, a rotary encoder or a differential transformer sensor). The extending direction of the stylus edge part 362 and the tilting direction of the stylus 360 are in the same plane. In addition, in order for the stylus edge part 362 to be pressed against the surface of an object to be measured with a predetermined measurement pressure, the stylus 360 (stylus arm part 361) is constantly biased in the one direction.

In addition, the probe 350 itself is rotatable relative to the head holder 340. The rotation axis of the probe 350 itself is parallel to the axial direction of the stylus arm part 361 (when the tilt angle αr of the stylus arm part 361 is zero degrees). A rotation angle Ωp of the probe 350 itself is detected by a probe rotation posture detector. However, the rotation angle Ωp of the probe 350 itself may be mechanically limited to either 0° or 90° to omit the probe rotation posture detector. By combining the rotation (Φ_{X}) of the head holder 340 with the rotation (Ωp) of the probe 350 itself, the stylus edge part 362 can be brought into contact with a workpiece from virtually any direction.

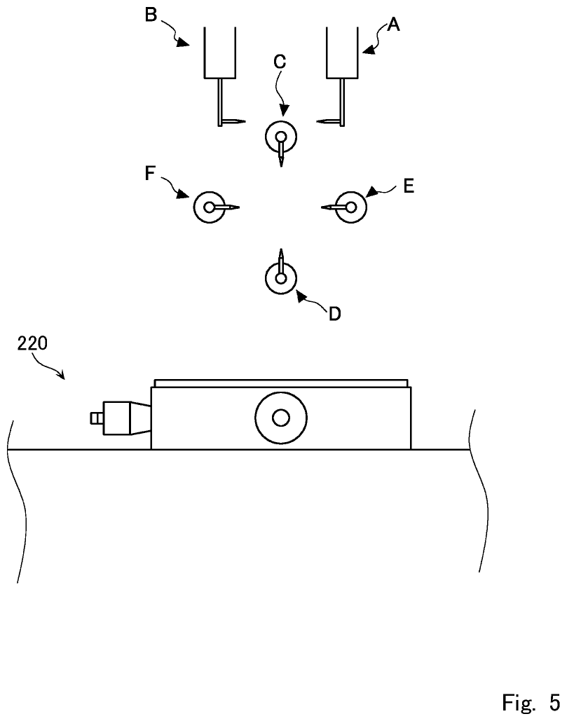

In FIG. 5, the reference sign A represents the vertical posture in an outside diameter measurement mode.

In FIG. 5, the reference sign B represents the vertical posture in an inside diameter measurement mode.

In FIG. 5, the reference sign C represents the horizontal posture in a top surface measurement mode.

In FIG. 5, the reference sign D represents the horizontal posture in a bottom surface measurement mode.

In FIG. 5, the reference sign E represents the horizontal posture in a right-side surface measurement mode.

In FIG. 5, the reference sign F represents the horizontal posture in a left-side surface measurement mode.

Here, using the stylus 360 as an example, the shape errors (shape parameters) of the components such as the stylus, the sensitivity (gain parameters) of the detectors, and the assembly errors (assembly error parameters) of the components such as the stylus are described.

In FIG. 6, the stylus 360 is axially supported by the probe body part 370 (not shown in FIG. 6) so as to rotate (tilt) about a rotation axis Ax as the rotation center. In the stylus arm part 361, the length from the rotation axis Ax to the base of the stylus edge part 362 is defined as a stylus arm length L₁. The stylus arm length L₁ is supposed to be machined to a design value L₁₀, but has a machining error of ΔL1. The stylus arm length L₁ (=L₁₀+ΔL1) is one of the shape parameters to be calibrated. Similarly, a length H of the stylus edge part 362 and the radius of curvature R at the tip of the stylus edge part (see the partial enlargement in FIG. 7) are the shape parameters to be calibrated.

In FIG. 7, the rotation angle αr of the stylus 360 is detected by a tilt angle detector 371. However, since the tilt angle detector 371 has a detection error (sensitivity error), the true rotation angle αr is calculated by adding a gain correction parameter gr of the tilt angle detector 371 to an angle detection value αr0 of the tilt angle detector 371. The gain correction parameter gr of the tilt angle detector 371 is one of the gain parameters to be calibrated.

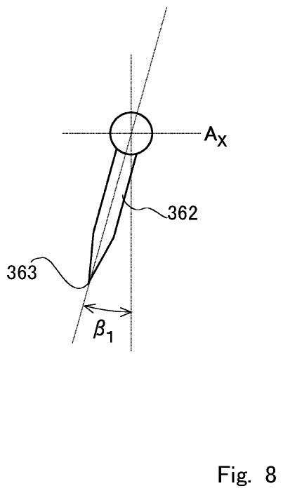

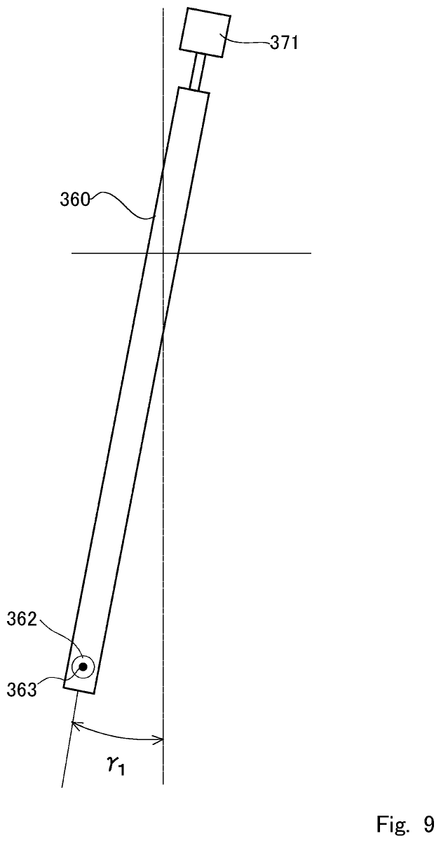

Next, the following are examples of the assembly errors. When the stylus 360 (stylus arm part 361) is viewed along its axis, the stylus edge part 362 should be perpendicular to the rotation axis Ax. However, in practical, there is an assembly angular error β1 as shown in FIG. 8. Similarly, the axis of the stylus 360 (stylus arm part 361) should be perpendicular to the rotation axis Ax, but, in practical, there is an assembly error γ1 as shown in FIG. 9.

In addition, as shown in the partial enlargement in FIG. 7, when the tilt angle detector 371 indicates 0° (or a zero-set value), the stylus 360 should be parallel (or at a predetermined angle) to the detector coordinate system of the tilt angle detector 371 (or to the reference line or plane defining the posture of the detector). However, in practical, there is a shift α1 as shown in FIG. 7.

Note that the assembly errors may be considered a type of shape parameter.

The host computer 110 is what is called a computer terminal including a central processing unit (CPU), a ROM and RAM that store predetermined programs, and provides predetermined operation commands to the motion controller 130 and performs calculation processing, such as shape analysis of an object to be measured (workpiece), based on data acquired by the measuring machine main body 200. Operation control programs (measurement part programs and calibration part programs) are installed on the host computer 110, and the overall operation of the roundness measuring apparatus (shape measuring apparatus) 100 is controlled by executing these programs. The method of supplying the programs is not limited; the programs may be installed by inserting a (non-volatile) storage medium recording the programs directly into the computer, by connecting a reading device that reads information from the storage medium to the computer and installing the programs from the reading device, or by supplying them to the computer via communication lines such as the Internet, LAN cables, telephone lines, or wireless means. In addition, the host computer 110 provides an input/output interface to a user via a monitor 112, keyboard, and mouse. The operation unit 120 includes control levers and buttons, and provides operation commands to the motion controller 130 through manual operation. The motion controller 130 performs drive control of the measuring machine main body 200.

The communication connection between the host computer 110, the motion controller 130, and the measuring machine main body 200 may be a wired connection, a wireless connection, or a remote connection via an Internet connection.

### (Calibration Jig)

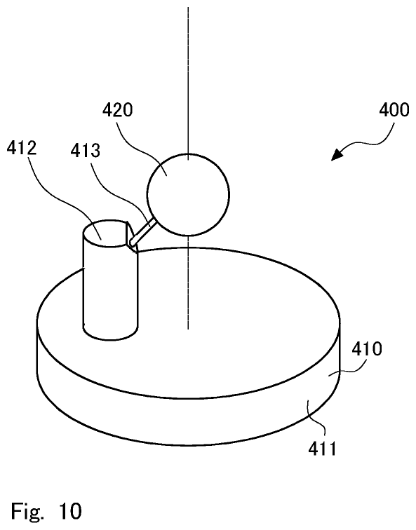

FIG. 10 shows a calibration jig used for parameter calibration in the present embodiment. A calibration jig 400 includes a mount part 410 and a reference sphere 420. The mount part 410 serves as a support for the reference sphere 420, and may be a simple plate-shaped body. Here, the mount part 410 is assumed to be disk-shaped, and its roundness and cylindricity are accuracy-finished. That is, the calibration jig 400 is configured in such a manner that centering and leveling can be performed using a side surface 411 of the mount part 410 as a reference. (However, since centering can also be performed using the reference sphere 420, it is not essential to specify the outside contour of the mount part 410.)

The reference sphere 420 is provided above the mount part 410. The reference sphere 420 is positioned in such a manner that its center point is on the center axis of the mount part 410. That is, when the mount part 410 is centered (centering can be performed manually or using the automatic centering function of the roundness measuring apparatus), the center point of the reference sphere 420 is positioned on the rotation axis of the rotary table 220.

Importantly, a radius r_{c} of the reference sphere 420 is known and guaranteed to be highly accurate.

On the upper surface of the mount part 410, a leg part 412 is provided in a standing manner, and a neck part 413 protrudes from the leg part 412 at an angle. That is, the neck part 413 is inclined relative to the center axis of the mount part 410. The reference sphere 420 is attached to the tip end of the neck part 413. Supporting the reference sphere 420 by the inclined neck part 413 is to expose the bottom surface of the reference sphere 420, to allow the bottom surface to be used for calibration.

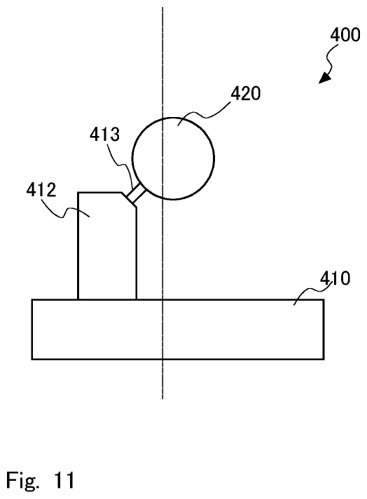

Note that, as will be described below, in the calibration in the present embodiment, it is preferable that the center point of the reference sphere 420 is slightly shifted from the rotation axis of the rotary table 220, which allows the gain parameters to be calibrated simultaneously. In practice, since minute errors remain even after manual or automatic centering, these errors may be utilized as is. However, considering that an appropriate shift should be consistently achieved, the reference sphere 420 may be intentionally shifted from the center axis of the mount part 410 in such a manner that the center point of the reference sphere 420 is offset from the center axis of the mount part 410 by a predetermined amount (for example, approximately 0.x micrometers). For example, FIG. 11 shows an example of the calibration jig 400 whose reference sphere 420 is intentionally disposed so as to be slightly shifted from the center axis of the mount part 410.

### (Calibration Method)

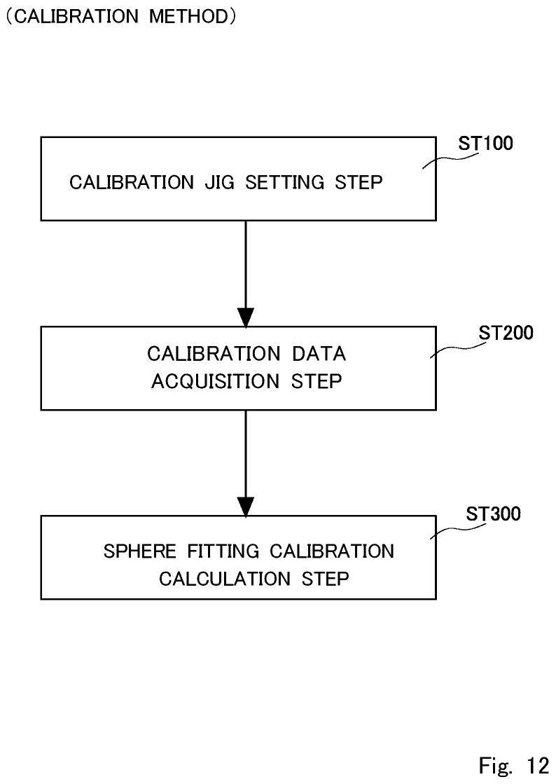

A calibration method for the roundness measuring apparatus according to the present embodiment includes a calibration jig setting step (ST100), a calibration data acquisition step (ST200), and a sphere fitting calibration calculation step (ST300) as shown in the flowchart in FIG. 12.

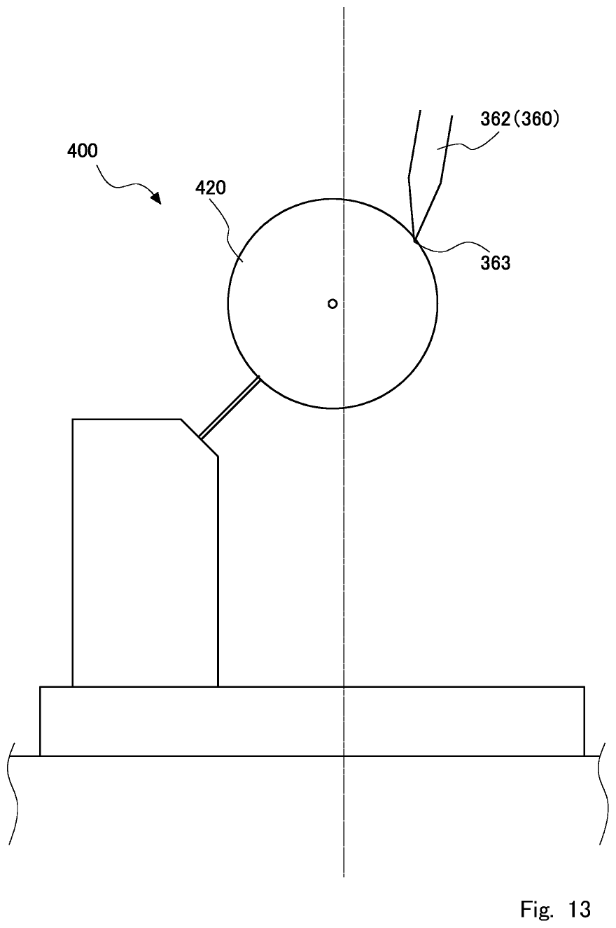

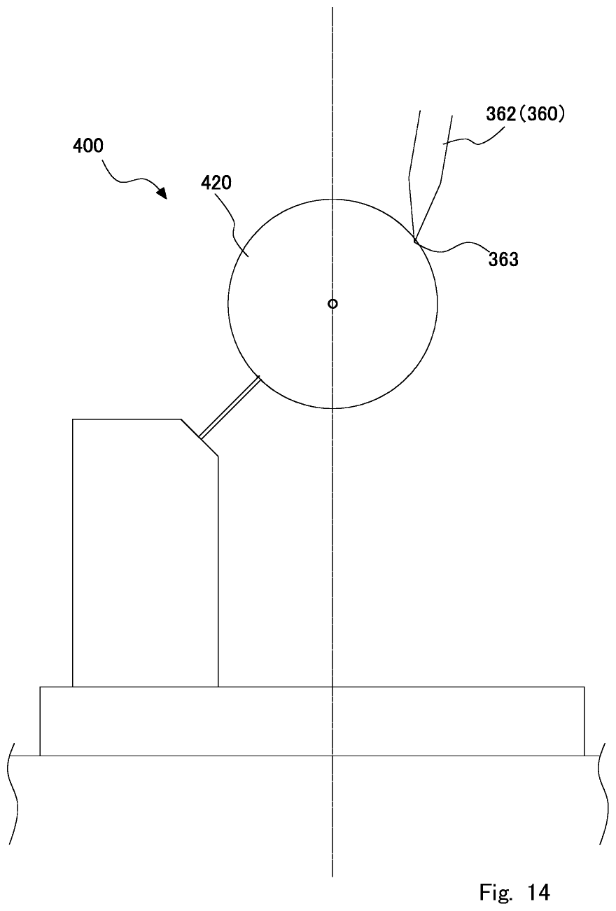

In the calibration jig setting step (ST100), the calibration jig 400 is set on the rotary table 220, and centered in such a manner that the center point of the reference sphere 420 is substantially aligned with the rotation axis of the rotary table 220. This state is shown in FIG. 13. Although FIG. 13 is somewhat exaggeratedly illustrated, it is desirable that the center point of the reference sphere 420 is slightly shifted from the rotation axis of the rotary table 220 as shown in FIG. 13. For example, as shown in FIG. 14, if the center point of the reference sphere 420 is perfectly aligned with the rotation axis of the rotary table 220, the measurement point (the contact point between the calibration sphere and the stylus) will not move. Even in this case, the shift between the rotation axis and the origin (origin offset parameter), the assembly posture of a component, such as the stylus, (assembly posture parameter), and the shape of a component, such as the stylus, (shape parameter) can be calibrated. However, calibration of the sensitivity of a detector (gain parameter) will not work effectively. To calibrate the gain parameter, the measurement point (the contact point between the calibration sphere and the stylus) needs to move to some extent, and for this to happen, the center point of the reference sphere 420 needs to be slightly shifted from the rotation axis of the rotary table 220. Since even manual or automatic centering leaves a minute error, this minute error can be utilized as is, or a slight shift can be intentionally created by turning any knob slightly.

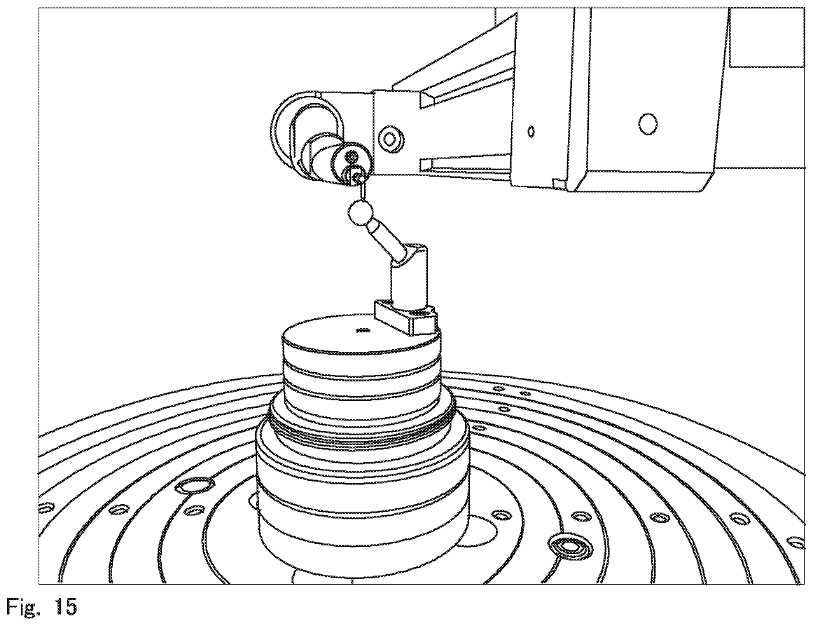

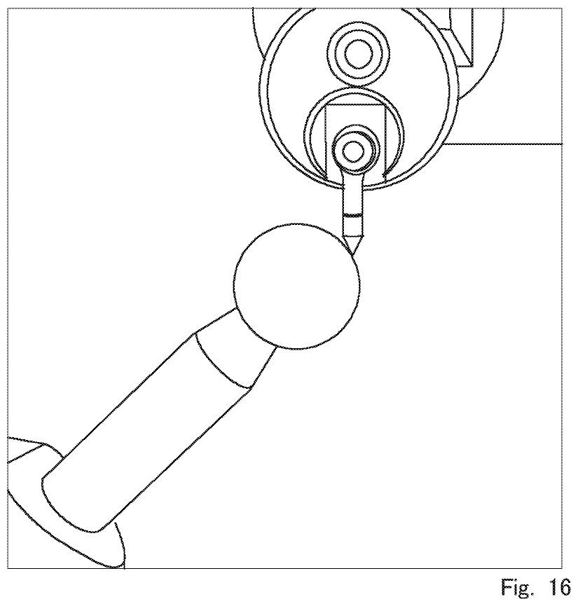

In this state, the stylus edge part 362 of the stylus 360 (probe 350) is brought into contact with the reference sphere 420. FIGS. 15 and 16 show an example of the state in which the stylus 360 is in contact with the reference sphere 420. Then, the rotary table 220 is rotated. In other words, while the reference sphere 420 is rotated, the surface of the reference sphere 420 is scanned and measured by the probe 350 (stylus part 362). At this time, since the reference sphere 420 is installed with a shift from the rotation axis, the reference sphere 420 slightly displaces as the rotary table 220 rotates, which causes a displacement in the stylus edge part 362 in contact with the surface of the reference sphere 420.

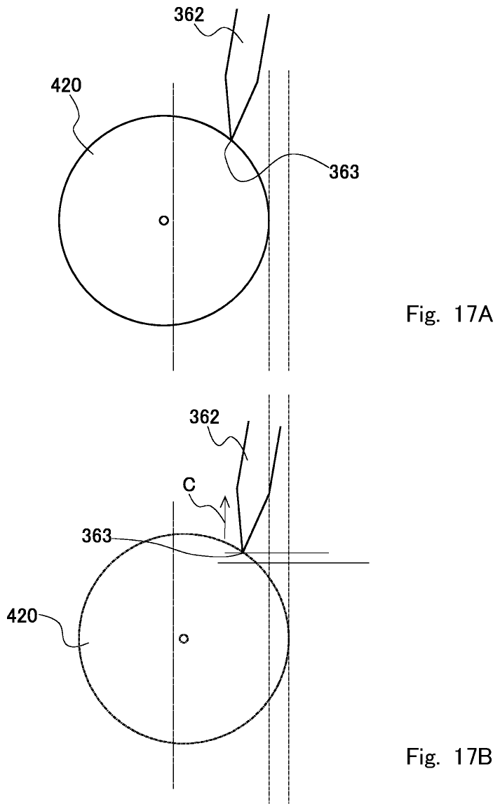

In FIG. 17, the stylus edge part 362 is illustrated at a slight angle to show that, as described earlier, the probe 350 (stylus 360) has assembly and shape errors, and the stylus edge part 362 can be slightly angled even in a vertical posture in a top-surface measurement mode. While the rotary table 220 rotates 180° from the state shown in FIG. 17A, a displacement occurs in the stylus edge part 362. The displacement of the stylus edge part 362 is detected by the tilt angle detector 371 as the rotation angle αr of the stylus 360.

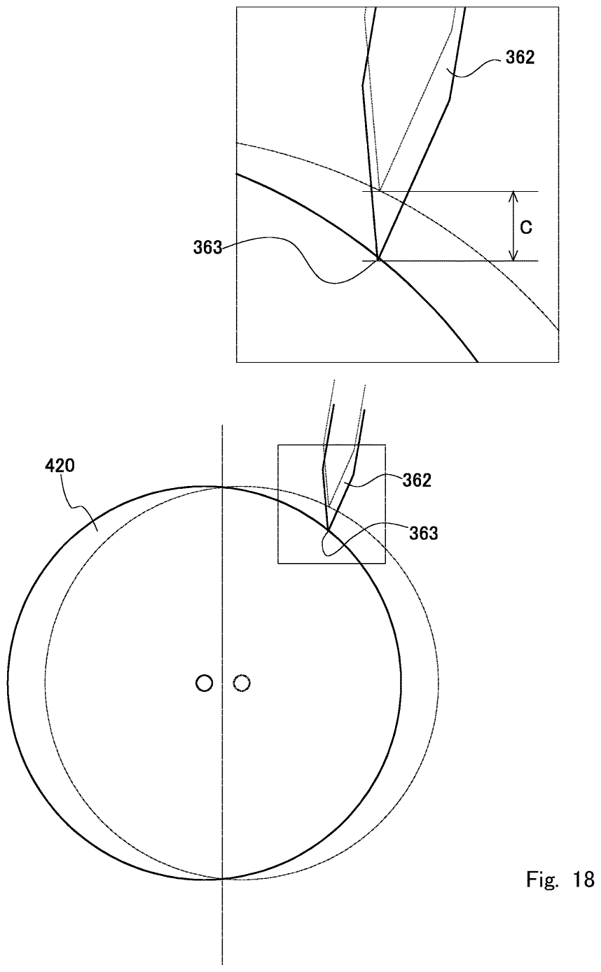

At this time, the contact point 363 of the stylus edge part 362 moves up and down (C) along the spherical surface (FIG. 18).

At this time, detection data from the respective detectors is sampled at regular intervals to obtain calibration data (calibration data acquisition step ST200). It is preferable to obtain a larger number of data samples. In addition, as will be described later, since the acquired data is applied to the sphere fitting calculation, it is naturally necessary to have more than one sampling point and to ensure that the data points are not all on a single straight line. The calibration data must be distributed to some extent across the spherical surface or a circle. The above requirements are satisfied by performing a scanning measurement of the surface of the reference sphere 420 with the probe 350 (stylus part 362) while the reference sphere 420 is rotated in order to acquire multiple pieces of calibration data.

The scanning measurement of the reference sphere 420 may be performed for less than one full rotation, or for more than one full rotation. For example, it may be performed for two or more full rotations. In addition, when the scanning measurement of the reference sphere 420 is performed, the probe 350 (stylus 360) may be moved in the X-axis direction to scan the reference sphere 420 in a concentric circular or spiral pattern.

The detection data from the respective detectors includes the following.

The rotation angle θ of the rotary table detected by the rotation detector (for example, a rotary encoder).

The height position (Z_{M}-direction position) Zm of the Z-slider 320 detected by the Z_{M}-direction position detector (a Z_{M}-direction encoder).

The X_{M}-direction position Xm of the X-arm 330 detected by the X_{M}-direction position detector (an X_{M}-direction encoder).

The rotation angle Φ_{X} (tilt angle) of the head holder 340 detected by the holder rotation angle detector (for example, a rotary encoder).

The rotation angle Ωp of the probe 350 itself detected by the probe rotation posture detector.

The tilt angle αr of the stylus 360 detected by the tilt angle detector (for example, a rotary encoder or a differential transformer sensor).

### (Sphere Fitting Calibration Calculation ST300)

By combining the acquired detection data (calibration data) with the initial values of the respective parameters and applying a certain type of forward kinematic transformation, a position p(x, y, z, θ) of the contact point 363 where the reference sphere 420 and the stylus edge part 362 come into contact is obtained. In the measurement coordinate system Σ_{RT} of a conventional roundness measuring apparatus, the position of the contact point 363 between the probe 350 and a workpiece has been represented in a polar coordinate system (ρ, θ) (or a cylindrical coordinate system (ρ, θ, z)) that assumes that the contact point 363 is on the X-axis. In other words, the y-component of p(x, y, z, θ) has been fixed to zero.

In this regard, the present embodiment takes into account that the probe 350 (stylus 360) has the assembly errors and shape errors of components. Therefore, in order to perform the calculation including the assembly errors and shape errors of the probe 350 (stylus 360) in the calibration targets as much as possible, the position of the contact point 363 is represented using the rotation angle θ of the rotary table and a three-dimensional spatial position (x, y, z, θ) representing the position when the rotation angle of the rotary table is θ, instead of fixing the y-component to zero, in the measurement coordinate system Σ_{RT}.

As described above, the roundness measuring apparatus is configured with multiple movable parts that rotate or translate and multiple detectors that acquire displacement information about the respective movable parts. A coordinate system Σₖ is set for each movable part and each detector, and a transformation matrix ^{k-1}Tₖ connecting the adjacent coordinate systems Σₖ₋₁ and Σₖ is determined by taking into account the parameters of the movable parts and detectors. The main parameters involved here include the sensitivity of the detector (gain parameter), the assembly posture of the component, such as the stylus, (assembly posture parameter), the shape of the component, such as the stylus, (shape parameter), and the shift between the rotation axis and the origin (origin offset parameter), which have been described above. Ultimately, the stylus edge contact point 363 can be determined from the detection values of the detectors, and the stylus edge contact point 363 can be represented as a point p(x, y, z, θ) in the measurement coordinate system Σ_{RT}.

The calibration data obtained from the scanning measurement while the reference sphere 420 is rotated is represented as pi(xi, yi, zi, θi).
xi: x1, x2, x3, . . .
yi: y1, y2, y3, . . .
zi: z1, z2, z3, . . .
θi: θ1, θ2, θ3, . . .

The center coordinate value of the reference sphere 420 is represented as C(cx, cy, cz, θ), which is unknown.

Now, the calibration data pi(xi, yi, zi, θi) is fitted into the spherical equation.

Then, the radius rᵢ of the sphere is as follows.

[Formula 1]

rᵢ=\sqrt{(x−cₓ)²+(y−c_{y})²+(z−c_{z})²} (1)

Here, the diameter of the reference sphere 420 is known, and the diameter of the reference sphere 420 is r_{c}.

The evaluation expression is represented by Formula 2.

[Formula 2]

fᵢ(L1,H,gr,α1,β1,γ1,Dx,Dy,cx,cy,cz)=rᵢ(L1,H,gr,α1,β1,γ1,Dx,Dy,cx,cy,cz)−r_{c} (2)

Then, the value obtained by Formula (3) is minimized.

$$\begin{matrix}[ Formula 3 ] & \\ {\sum }_{i = 1}^{n} \vert {f}_{i} \vert & ( 3 )\end{matrix}$$

That is, the origin and the parameters are determined (adjusted) in such a manner that the value obtained by Formula (4) is minimized.

$$\begin{matrix}[ Formula 4 ] & \\ {\sum }_{i = 1}^{n} {f}_{i}^{2} & ( 4 )\end{matrix}$$

In other words, this is a least squares method that uses sphere fitting. The subsequent calculations follow the standard least squares method. Since various calculation methods are known, the appropriate one is applied as needed. The following is merely an example of such a method and should not be interpreted as the only valid solution.

The calibration targets are L1, H, gr, α1, β1, γ1, Dx, and Dy. These are representative parameters that significantly affect measurement accuracy and should be calibrated. However, the sensitivity of other detectors (gain parameters), the assembly posture of other components (assembly posture parameters), and the shape of other components (shape parameters) may also be included in the calibration targets. The calibration targets is only required to be determined as appropriate, taking into account the computational load.

Note that it is preferable to adjust the radius of curvature R of the contact point 363 at the tip end of the stylus edge part 362 last, after calibrating the other parameters. Here, the radius of curvature R of the contact point 363 at the tip end of the stylus edge part 362 is omitted. However, when the radius of curvature R of the contact point 363 is included, the nominal dimension of the radius of curvature R of the contact point 363 is included, and the evaluation formula becomes fᵢ=rᵢ−(r_{c}+R).

The Jacobian matrix is represented as J.

$$\begin{matrix}[ Formula 5 ] & \\ J = \frac{\partial r}{\partial ( L 1 , H , gr , α 1 , β 1 , γ 1 , Dx , Dy , {c}_{x} , {c}_{y} , {c}_{z} )} & ( 5 )\end{matrix}$$

The column vector b is represented as follows.

$$\begin{matrix}[ Formula 6 ] & \\ \vec{b} = ( \begin{matrix}Δ L 1 \\ Δ H \\ Δ gr \\ Δ α 1 \\ Δ β 1 \\ Δ γ 1 \\ Δ Dx \\ Δ Dy \\ Δ cx \\ Δ cy \\ Δ cz\end{matrix} ) & ( 6 )\end{matrix}$$

The column vector representing a target fᵢ is represented as vector f.

$$\begin{matrix}[ Formula 7 ] & \\ \vec{f} = ( \begin{matrix}{f}_{1} \\ {f}_{2} \\ {f}_{3} \\ \cdot \\ {f}_{i} \\ \cdot \\ {f}_{n}\end{matrix} ) & ( 7 )\end{matrix}$$

Then, the following formula is solved.

[Formula 8]

\vec{b}=−(J^{T}J)⁻¹J^{T}\vec{f}(L1,H,gr,α1,β1,γ1,Dx,Dy,cx,cy,cz) (8)

Using the determined column vector b, the calibration targets L1, H, gr, α1, β1, γ1, Dx, and Dy are updated.

(L1,H,gr,α1,β1,γ1,Dx,Dy)+(ΔL1,ΔH,Δgr,Δα1,Δβ1,Δτ1,ΔDx,ΔDy)→(L1,H,gr,α1,β1,γ1,Dx,Dy)

This process is repeated a predetermined number of times or until the sum of the absolute values of the differences (Σ|fᵢ|) becomes sufficiently small. Note that there are various other methods for optimizing the parameters, and any appropriate method may be used without limitation to this one. In this manner, the calibration target parameters L1, H, gr, α1, β1, γ1, Dx, and Dy can be calibrated with extremely high accuracy.

Since the origin offset parameter is mechanically determined by the structure of the roundness measuring apparatus and does not change with each measurement, once the origin offset parameter has been calibrated, the same value may be used.

In the above description, calibration is performed using the top surface of the reference sphere in the top-surface measurement mode. If calibration is also performed in a bottom-surface measurement mode, the origin offset parameter can be obtained for the height in the bottom-surface measurement. This allows the rotation axis vector (the inclination of the rotation axis) of the rotary table 220 to be determined.

By performing the calibration according to the present embodiment for each measurement mode, gain calibration can be performed for each measurement mode, and measurement accuracy is improved by applying the gain adjustment rate for each measurement mode.

The following are notable effects of the disclosure.

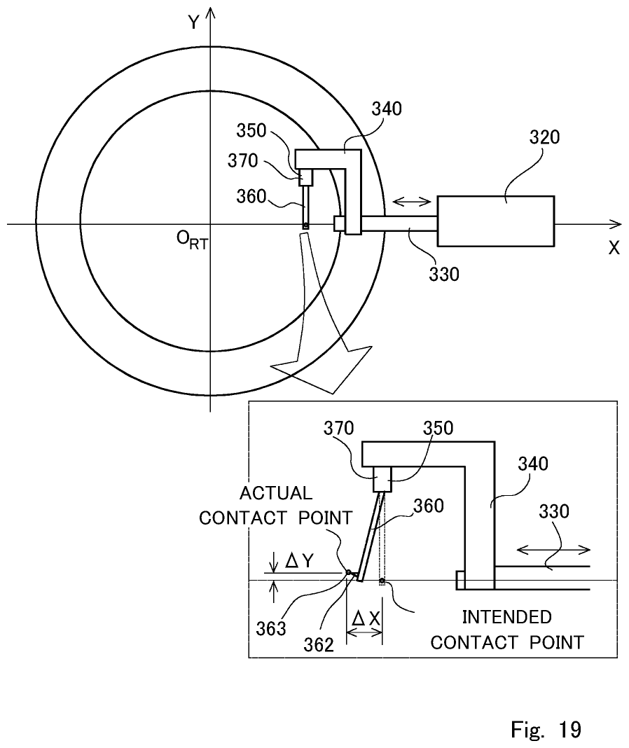

The roundness measuring apparatus brings the probe 350 close to a workpiece from one direction and measures the external shape of the workpiece while rotating the workpiece on the rotary table 220. As shown in FIG. 19, the forward/backward movement direction of the probe 350 is essentially limited to the forward/backward movement direction of the X-arm 330 (along the X-axis). Therefore, due to its configuration, the roundness measuring apparatus has assumed that the intended measurement point (the contact point between the workpiece and the contact point 363) is on this single axis (the measurement axis). (This applies to both vertical and horizontal postures. Origin calibration and alignment with the measurement axis are performed regardless of the posture.)

However, in practical, due to shape errors (for example, ΔL1 and ΔH) and assembly errors (for example, β1 and γ1), the actual measurement point (the contact point between the workpiece and the contact point 363) is slightly shifted from the X-axis (measurement axis), albeit by an extremely small amount. This shift Δ(ΔX, ΔY) is so small that it has not caused a problem under conventional accuracy requirements. In addition, even if there is no shift (the contact point 363 being at the intended position on the X-axis (measurement axis)), this has not caused a problem by performing the conventional origin calibration and axis alignment procedures. (Alternatively, there is no specific method to calibrate this error, and improving the accuracy of machine components and assembly has been the best countermeasure.) However, the inventors have recognized this as a problem that needed to be solved, considering the evaluation of shape tolerances of accuracy-machined workpieces (micro-gears) and aspheric lenses (optical components). In this regard, according to the calibration method of the present embodiment, it is possible to calibrate almost all parameters with high precision and in a short time, and to regard the acquired measurement data as measurement data at the actual (real) measurement point (the contact point between the workpiece and the contact point 363). That is, by taking into account, for example, {L1, H, gr, α1, β1, γ1} among the parameters to be calibrated, the location of the tip end of the stylus edge part 362 (contact point 363) can be accurately determined in three dimensions (x, y, z). Furthermore, 0° of the rotary table can be accurately calibrated in accordance with the shift of the tip end of the stylus edge (contact point 363). The measurement data may be provided as (x, y, z, θ) or in polar coordinates (ρ, θ) (or cylindrical coordinates (ρ, θ, z)). In this case, a distance ρ (radial distance) between the origin (or rotation axis) and the contact point 363 is represented by Formula 9.

[Formula 9]

ρ=\sqrt{x²+y²} (9)

Formula 10 is considered for the angle θ.

$$\begin{matrix}[ Formula 10 ] & \\ Δ θ = arcsin ( \frac{y}{ρ} ) & ( 10 )\end{matrix}$$

This will result in a dramatic improvement in the accuracy of the measurement data.

Furthermore, by establishing this calibration method, measurement accuracy can be maintained at a high level even if the accuracy of components or the assembly accuracy is slightly compromised. Consequently, this calibration method has the potential to significantly reduce the manufacturing costs of shape measuring apparatuses (roundness measuring apparatuses).

The experimental results are presented below.

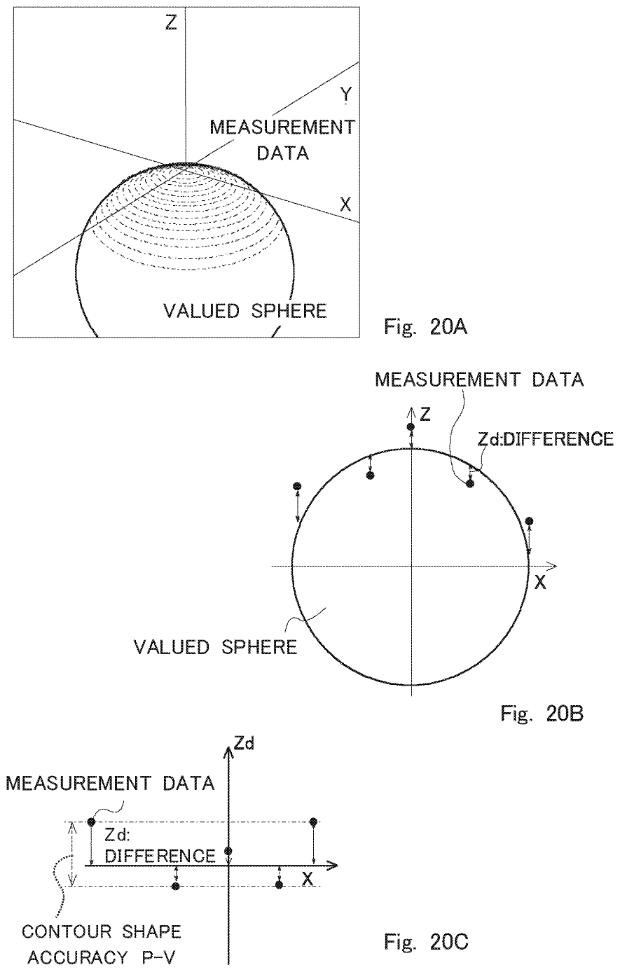

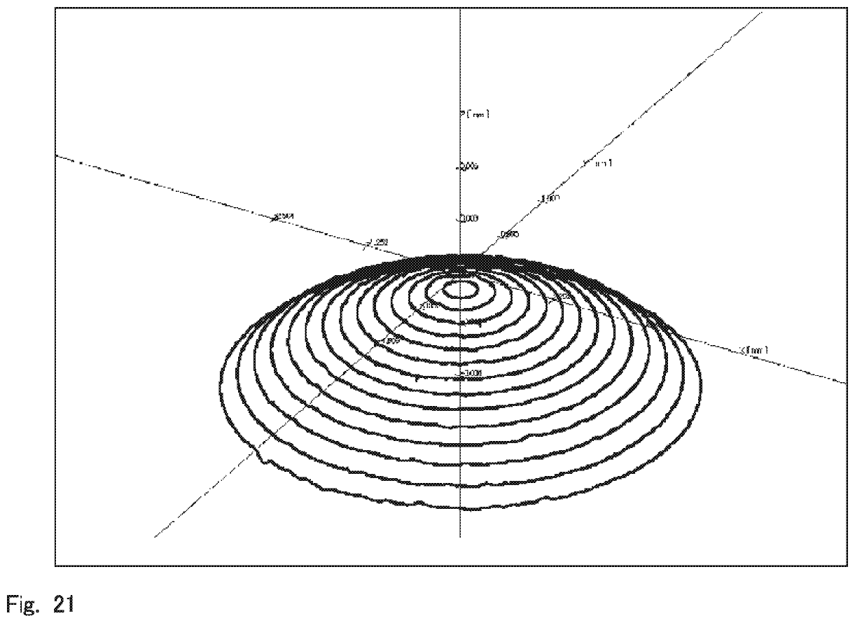

As a conventional method, origin calibration of the roundness measuring apparatus was performed using the calibration sphere disclosed in JP 2004-317159 A or JP 2017-15437 A. Then, the upper surface of a valued sphere (that is, having a known diameter) was measured in the top-surface measurement mode (see FIG. 20A). The measurement results were compared with the valued sphere (see FIG. 20B), and the differences were plotted (see FIG. 20C). The results are shown in FIG. 21. The contour shape accuracy P-V (magnitude of the difference, see FIG. 20C) was 6.179 μm, with a particularly large difference observed near the apex.

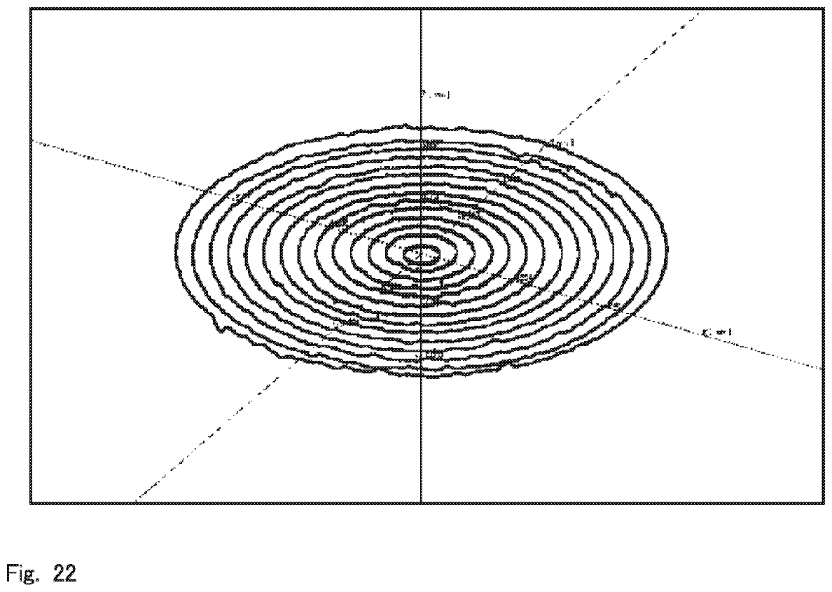

The roundness measuring apparatus was calibrated using the method of the present embodiment, and the same measurement was performed as above. The results are shown in FIG. 22. The contour shape accuracy P-V (magnitude of the difference) was 0.627 μm, which indicates that there is no overall difference.

### Second Exemplary Embodiment

In the first exemplary embodiment, nearly all of the parameters of the roundness measuring apparatus are to be calibrated. The first exemplary embodiment has described, as an example that, by considering, for example, {L1, H, gr, α1, β1, γ1} among the parameters to be calibrated, the exact location of the tip end of the stylus edge part 362 (contact point 363) in the measurement coordinate system Σ_{RT} can be determined. A second exemplary embodiment describes a case in which a shape measuring apparatus other than the roundness measuring apparatus is to be calibrated.

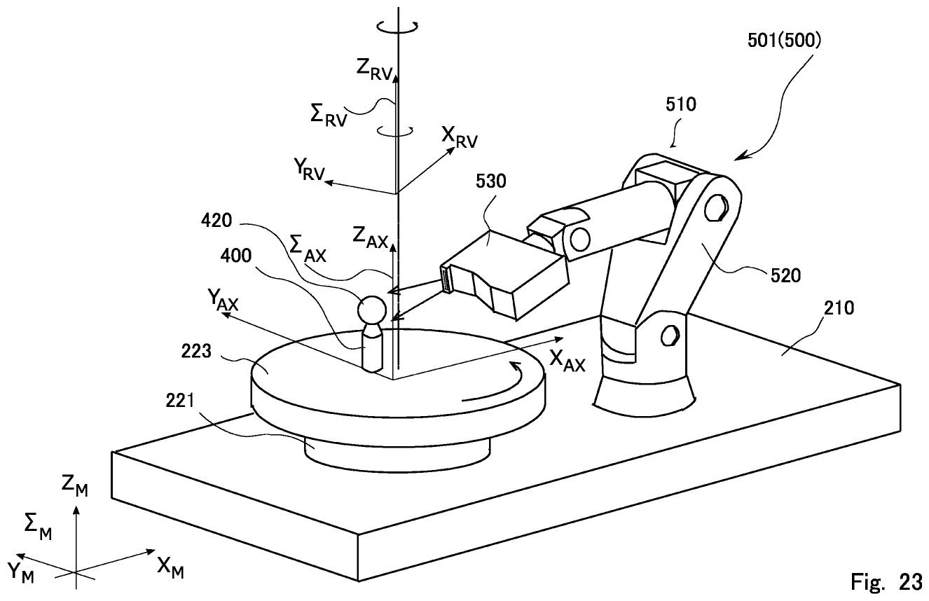

FIG. 23 is a diagram showing an example of a shape measuring apparatus 500 to be calibrated. Here, a measuring machine main body 501 of the shape measuring apparatus 500 is shown. Its host computer, control unit, motion controller, and the like should be considered the same as those in the first exemplary embodiment. Note that the configuration of the shape measuring apparatus 500 to be calibrated is not limited to this. Other examples of the shape measuring apparatus 500 will be described later.

The measuring machine main body 501 includes a base 210, a rotary table 220, and a coordinate measuring unit 510.

The rotary table 220 is the same as that in the first exemplary embodiment. The rotary table 220 includes a rotary drive unit (rotary mechanism) 221 and a stage (workpiece holding stage) 223. The rotation angle θ is detected by a rotation detector (for example, a rotary encoder).

Two coordinate systems are defined using the rotary table (rotary mechanism) 220 as the reference. These two coordinate systems are referred to as a fixed-axis coordinate system Σ_{AX} and a rotational coordinate system Σ_{RV}.

The fixed-axis coordinate system Σ_{AX} is a coordinate system that uses the rotation axis of the rotary table (rotary mechanism) 220 as the reference. Here, it is assumed that a Z_{AX} axis of the fixed-axis coordinate system Σ_{AX} coincides with the rotation axis of the rotary table (rotary mechanism) 220. In addition, within a plane orthogonal to the Z_{AX} axis of the fixed-axis coordinate system Σ_{AX}, mutually orthogonal X_{AX} and Y_{AX} axes are defined. The fixed-axis coordinate system Σ_{AX} is a fixed coordinate system that does not move even when the rotary table (rotary mechanism) 220 rotates. In FIG. 23, the Z_{AX} axis of the fixed-axis coordinate system Σ_{AX} is shown as not overlapping with the rotation axis for the clarity in the illustration.

The rotational coordinate system Σ_{RV} is also a coordinate system that uses the rotation axis of the rotary table (rotary mechanism) 220 as the reference, but it rotates along with the rotation of the rotary table (rotary mechanism) 220. Here, it is assumed that a Z_{RV} axis of the rotational coordinate system Σ_{RV} coincides with the rotation axis of the rotary table (rotary mechanism) 220. In addition, within a plane orthogonal to the Z_{RV} axis of the rotational coordinate system Σ_{RV}, mutually orthogonal X_{RV} and Y_{RV} axes are defined. However, the X_{RV} and Y_{RV} axes rotate along with the rotation of the rotary table (rotary mechanism) 220. In other words, the rotational coordinate system Σ_{RV} is installed on the stage (workpiece holding stage) 223 and rotates together with a workpiece (object to be measured) and a calibration jig 400.

The rotation axis of the rotary table (rotary mechanism) 200 certainly exists, and the accuracy of the rotation axis (rotational accuracy) of the rotary drive unit 221 is adjusted with extremely high precision. That is, even when the rotary table (rotary mechanism) 220 rotates, the rotation axis does not move or tilt. However, at this point, the host computer of the shape measuring apparatus 500 does not fully grasp the position or posture of the rotation axis. The host computer (or its processing unit) establishes (creates) the two coordinate systems described above—the fixed-axis coordinate system Σ_{AX} and the rotational coordinate system Σ_{RV}—relative to the rotation axis of the rotary table (rotary mechanism) 220, which is assumed to exist. As long as the origin of the fixed-axis coordinate system Σ_{AX} is on the rotation axis, the position (height) on the rotation axis is only required to be set as appropriate. Similarly, as long as the origin of the rotational coordinate system Σ_{RV} is on the rotation axis, and the position (height) on the rotation axis is only required to be set as appropriate.

The coordinate measuring unit 510 is now described. In the second exemplary embodiment, the coordinate measuring unit 510 includes an articulated robot 520 serving as a sensor holding mechanism, and a surface measuring sensor 530 held at the tip end of the articulated robot 520.

The articulated robot 520 moves the surface measuring sensor 530 to a predetermined position and posture. Specifically, the articulated robot 520 moves the surface measuring sensor 530 to capture an object to be measured on the rotary table 220 within the measurement range. During the measurement operation of measuring the overall shape of the object to be measured, the articulated robot 520 remains stationary, and the position and posture of the surface measuring sensor 530 are also fixed. The rotary table (rotary mechanism) 220 is used to move the object to be measured and the surface measuring sensor 530 relative to each other in order to measure the entire object to be measured (or a sufficiently wide range thereof).

Here, the surface measuring sensor 530 is assumed to be a line laser sensor. Broadly speaking, the surface measuring sensor 530 is included in a probe (measuring head) that detects the surface of the object to be measured. However, in the second exemplary embodiment, the surface measuring sensor 530 is capable of measuring at least two or more points on the surface of the object to be measured in a single measurement operation (or a series of operations). Furthermore, the surface measuring sensor itself has a three-dimensional sensor coordinate system Σ_{S} and can identify the positions of the acquired measurement points within the sensor coordinate system Σ_{S}. Moreover, the relative positional relationships between the acquired measurement points within the sensor coordinate system Σ_{S} are assumed to be highly precise.

For example, the line laser sensor has a planar image sensor as its light-receiving element. Light emitted from a laser light source is reflected by the object to be measured, and the reflected light enters the image sensor. The position of the surface of the object to be measured can be determined from the position where the reflected light has been received on the image sensor.

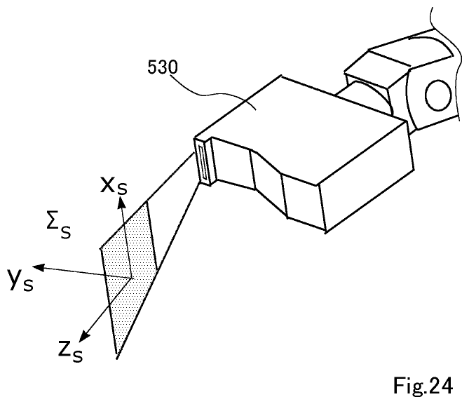

FIG. 24 is a conceptual diagram showing the sensor coordinate system Σ_{S}.

For example, an Xs-axis and a Zs-axis are defined as being parallel to the plane of the measurement area of the line laser sensor, and the YS-axis is defined in a direction perpendicular to the plane of the measurement area of the line laser sensor. Then, from the position where the reflected light has been received, sensor data m_{S}(m_{Sx}, m_{Sy}, m_{Sz}) indicating the spatial position of the surface of the object to be measured in the sensor coordinate system Σ_{S} is obtained.

Note that, in this case, m_{Sy}=0.

However, since the line laser sensor can only measure a specific range (a single line) of the surface of the object to be measured, it is necessary to rotate the object to be measured using the rotary table 220 to measure the entire object to be measured (or at least a sufficiently wide range). Then, the sensor data m_{S}(m_{Sx}, m_{Sy}, m_{Sz}) acquired at different rotation angles of the rotary table 220 are combined and represented in a single coordinate system, in this case, the rotational coordinate system Σ_{RV}. At this time, it is necessary to correctly grasp the relative position and relative posture between the surface measuring sensor 530 and the rotary table 220 (rotational coordinate system Σ_{RV}), which means that it is necessary to correctly calibrate the relative position and relative posture of the surface measuring sensor 530.

The calibration jig 400 only needs to have a known shape. For example, the calibration jig 400 may be a rectangular parallelepiped with known dimensions. Alternatively, the calibration jig 400 may be a perfect sphere with a known diameter. Alternatively, the calibration jig 400 may have an unknown diameter as long as it is a perfect sphere. Here, it is assumed that the calibration jig 400 includes a reference sphere 420, which is a perfect sphere.

### (Calibration Method)

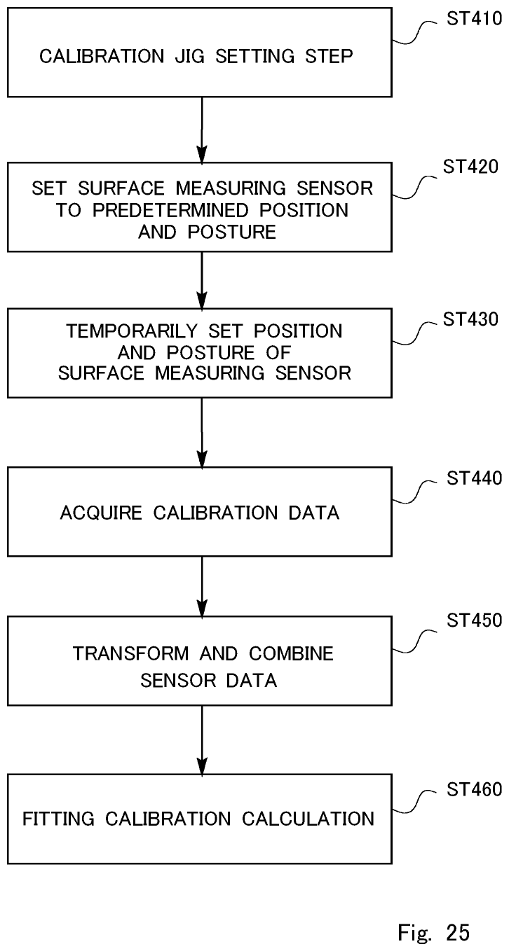

A calibration method of the second exemplary embodiment will be described in the order of the flowchart in FIG. 25.

FIG. 25 is a flowchart showing a procedure of the calibration method of the second exemplary embodiment. First, the calibration jig 400 is set on the rotary table 220 (calibration jig setting step (ST410)). At this time, it is preferable that the center of the reference sphere 420 is slightly shifted from the rotation axis.

Next, the articulated robot 520 is driven to set the line laser sensor (surface measuring sensor) 530 to a predetermined position and posture (ST420). Then, the position and posture of the line laser sensor (surface measuring sensor) 530 is temporarily set (ST430). The position and posture of the line laser sensor (surface measuring sensor) 530 in the fixed-axis coordinate system Σ_{AX} are represented by vector p as follows, for example.

p=(ρₓ,ρ_{y},ρ_{z},τₓ,τ_{y},τ_{z})

Note that, τₓ, τ_{y}, and τ_{z} correspond to the x, y, and z positions of the origin of the sensor coordinate system Σ_{S} in the fixed-axis coordinate system Σ_{AX}. Regarding ρₓ, ρ_{y}, and ρ_{z}, ρₓ corresponds to the rotation about the X_{AX} axis in the fixed-axis coordinate system Σ_{AX} of the sensor coordinate system Σ_{S}, ρ_{y} corresponds to the rotation about the Y_{AX} axis, and ρ_{z} corresponds to the rotation about the Z_{AX} axis.

Then, the transformation matrix T(p) that transforms the sensor data m_{S}(m_{Sx}, m_{Sy}, m_{Sz}) acquired by the line laser sensor (surface measuring sensor) 530 into a point in the fixed-axis coordinate system Σ_{AX} can be represented as follows using homogeneous coordinates. The transformation matrix T(p) only need to be a matrix capable of transforming the sensor data m_{S}(m_{Sx}, m_{Sy}, m_{Sz}) into a point in the fixed-axis coordinate system Σ_{AX}, and is not limited to the example described herein.

$$\begin{matrix}[ Formula 11 ] & \\ T ( p ) = [ \begin{matrix}1 & 0 & 0 & {τ}_{x} \\ 0 & 1 & 0 & {τ}_{y} \\ 0 & 0 & 1 & {τ}_{z} \\ 0 & 0 & 0 & 1\end{matrix} ] [ \begin{matrix}cos {ρ}_{z} & - sin {ρ}_{z} & 0 & 0 \\ sin {ρ}_{z} & cos {ρ}_{z} & 0 & 0 \\ 0 & 0 & 1 & 0 \\ 0 & 0 & 0 & 1\end{matrix} ] [ \begin{matrix}cos {ρ}_{y} & 0 & - sin {ρ}_{y} & 0 \\ 0 & 1 & 0 & 0 \\ - sin {ρ}_{y} & 0 & cos {ρ}_{y} & 0 \\ 0 & 0 & 0 & 1\end{matrix} ] [ \begin{matrix}1 & 0 & 0 & 0 \\ 0 & cos {ρ}_{x} & - sin {ρ}_{x} & 0 \\ 0 & sin {ρ}_{x} & cos {ρ}_{x} & 0 \\ 0 & 0 & 0 & 1\end{matrix} ] & ( 11 )\end{matrix}$$

Next, while the rotary table 220 is rotated, surface shape data of the calibration jig 400 is acquired using the line laser sensor (surface measuring sensor) 530 (ST440).

Once sensor data for one full rotation of the rotary table 220 has been acquired, the sensor data in the sensor coordinate system Σ_{S} is transformed into data in the rotational coordinate system Σ_{RV} and combined (ST450). It is assumed that Ns pieces of sensor data are acquired from a single line scanning measurement (or series of measurements) by the line laser sensor (surface measuring sensor) 530. In addition, the index used to distinguish the N_{S}(j) pieces of sensor data acquired in a single measurement (or series of measurements) is represented as “i”. That is, i=1, 2, 3, . . . , N_{S}(j). Note that j is the index indicating the rotation angle shown below.

In addition, the number of measurements during one rotation of the rotary table 220 is represented as N_{R}, and the index used to distinguish the NR angle values is represented as “j”. That is, j=1, 2, 3, . . . , N_{R}, and the angle values are θ₁, θ₂, θ₃, . . . , θⱼ, . . . , θ_{NR}. Then, the rotation about the rotation axis is represented as follows.

$$\begin{matrix}[ Formula 12 ] & \\ X ( {θ}_{j} ) = [ \begin{matrix}cos {θ}_{j} & - sin {θ}_{j} & 0 & 0 \\ sin {θ}_{j} & cos {θ}_{j} & 0 & 0 \\ 0 & 0 & 1 & 0 \\ 0 & 0 & 0 & 1\end{matrix} ] & ( 12 )\end{matrix}$$

Here, the i-th data among the N_{S} pieces of data acquired by the line laser sensor (surface measuring sensor) 530 when the rotation angle of the rotary table 220 is θⱼ is represented as m_{S}(i, j). Then, m_{S}(i, j) is represented by the following vector.

$$\begin{matrix}[ Formula 13 ] & \\ {m}_{s \{ i , j \}} = [ \begin{matrix}{m}_{sx \{ i , j \}} \\ {m}_{sy \{ i , j \}} \\ {m}_{sz \{ i , j \}} \\ 1\end{matrix} ] & ( 13 )\end{matrix}$$

With these preparations, the formula that transforms the sensor data m_{S}(i, j) in the sensor coordinate system Σ_{S} into data mₜ(i, j) in the rotational coordinate system Σ_{RV} is represented as follows.

$$\begin{matrix}[ Formula 14 ] & \\ {m}_{t \{ i , j \}} = [ \begin{matrix}{m}_{tx \{ i , j \}} \\ {m}_{tx \{ i , j \}} \\ {m}_{tz \{ i , j \}} \\ 1\end{matrix} ] & ( 14 )\end{matrix}$$

$$\begin{matrix}[ Formula 15 ] & \\ {m}_{t \{ i , j \}} = X ( {θ}_{j} ) T ( p ) {m}_{s \{ i , j \}} & ( 15 )\end{matrix}$$

The shape data of the calibration jig 400 acquired as calibration data is transformed into data mₜ(i, j) in the rotational coordinate system Σ_{RV}. Next, in a fitting calculation (ST460), the position and posture vector p of the line laser sensor (surface measuring sensor) 530 is adjusted.

Although various adjustment methods are conceivable, the least squares method is used to fit the data mₜ(i, j) to a sphere.

The following is an example of an evaluation formula E that represents the residuals of the sphere for the data mₜ(i, j).

$$\begin{matrix}[ Formula 16 ] & \\ E = \frac{1}{n} {\sum }_{i = 1}^{n} {\sum }_{j = 1}^{m} {( \sqrt{{( {m}_{tx \{ i , j \}} - {c}_{x} )}^{2} + {( {m}_{ty \{ i , j \}} - {c}_{y} )}^{2} + {( {m}_{tz \{ i , j \}} - {c}_{z} )}^{2}} - {r}_{c} )}^{2} & ( 16 )\end{matrix}$$

$$\begin{matrix}[ Formula 17 ] & \\ E = \frac{1}{n} {\sum }_{i = 1}^{n} {\sum }_{j = 1}^{m} {( \sqrt{{( {m}_{tx \{ i , j \}} - {c}_{x} )}^{2} + {( {m}_{ty \{ i , j \}} - {c}_{y} )}^{2} + {( {m}_{tz \{ i , j \}} - {c}_{z} )}^{2}} - {r}_{c} )}^{2} & ( 17 )\end{matrix}$$

$$\begin{matrix}[ Formula 18 ] & \\ E = max ( {( \sqrt{{( {m}_{tx \{ i , j \}} - {c}_{x} )}^{2} + {( {m}_{ty \{ i , j \}} - {c}_{y} )}^{2} + {( {m}_{tz \{ i , j \}} - {c}_{z} )}^{2}} - {r}_{c} )}^{2} ) & ( 18 )\end{matrix}$$

Note that max( ) is a function that returns the largest value from a given set of values. Here, it calculates the values within the brackets within the range i=1, 2, 3, . . . , N_{S} and j=1, 2, 3, . . . , N_{R}, and returns the largest value among them.

There is also a method shown below that does not use the radius r of the sphere.

$$\begin{matrix}[ Formula 19 ] & \\ {e}_{i , j} = ( \sqrt{{( {m}_{tx \{ i , j \}} - {c}_{x} )}^{2} + {( {m}_{ty \{ i , j \}} - {c}_{y} )}^{2} + {( {m}_{tz \{ i , j \}} - {c}_{z} )}^{2}} & ( 19 )\end{matrix}$$

$$E = max ( {e}_{i , j} ) - min ( {e}_{i , j} )$$

Here, min( ) is a function that returns the minimum value from a given set of values.

Alternatively, the evaluation formula can be written as follows.

[Formula 20]

E=var(e_{i,j}) (20)

Note that var( ) is a function that represents the variance of a given set of values. Here, it refers to the variance of all e_{i,j} within the range i=1, 2, 3, . . . , N_{S} and j=1, 2, 3, . . . , N_{R}.

The position and posture vector p of the line laser sensor (surface measuring sensor) 530 for which E is minimized in the evaluation formulae described above is sought.

Once this vector p is determined, the accurate position and posture of the line laser sensor (surface measuring sensor) 530 are obtained, and mₜ{i, j} (=X(θⱼ)·T(p)·mₛ{i, j}), which is transformed and combined based on this position and posture information, represents the accurate shape of the object to be measured.

However, in the derivation of the formulae up to this point, the only reference axis is the rotation axis of the rotary table 220, and phase information ρ_{z} relative to the rotation axis of the line laser sensor (surface measuring sensor) 530 and the height (Z_{AX} coordinate value) τ_{z} of the line laser sensor (surface measuring sensor) remain undetermined.

Since the rotational coordinate system Σ_{RV} and the sensor coordinate system Σ_{S} are in a relative relationship, E will be minimized in the same manner even if both move together in the height direction or rotate together about the rotation axis.

In other words, the above formulae cannot uniquely determine the value of p that minimizes E by solving the evaluation equation.

Mathematically, the following are methods for specifying constraint conditions to uniquely determine the position and posture vector p of the line laser sensor (surface measuring sensor) 530.

### Example 1 of Constraint Conditions

The phase information ρ_{z} relative to the rotation axis of the line laser sensor (surface measuring sensor) 530 and the height (Z_{AX} coordinate value) T_{z} of the line laser sensor (surface measuring sensor) 530 are fixed at arbitrary values, and the vector p is then determined to minimize the evaluation expression E described above. For example, ρ_{z}=0 and τ_{z}=0 are initially set. This determines the positional relationship between the fixed-axis coordinate system Σ_{AX} and the line laser sensor (surface measuring sensor) 530 in such a manner that the X_{AX} axis of the fixed-axis coordinate system Σ_{AX} passes through the origin of the sensor coordinate system Σ_{S} of the line laser sensor (surface measuring sensor) 530.

### Example 2 of Constraint Conditions

The center coordinates of the reference sphere of the calibration jig are fixed to either (1) cy=0, cz=0, or (2) cx=0, cz=0.

In case (1), the rotational coordinate system Σ_{RV} is set in such a manner that the X_{RV} axis of the rotational coordinate system Σ_{RV} passes through the center of the reference sphere.

In case (2), the rotational coordinate system Σ_{RV} is set in such a manner that the Y_{RV} axis of the rotational coordinate system Σ_{RV} passes through the center of the reference sphere.

### Example 3 of Constraint Conditions

There is also an approach where calculations are firstly performed with ρ_{z} and τ_{z} fixed as in the example 1 of constraint conditions to temporarily obtain vector p, and then ρ_{z} and τ_{z} are refined. Specifically, the vector p with which E is minimized is sought with ρ_{z}=0 and τ_{z}=0 fixed. The obtained p is used to write Txy=T(p).

[Formula 21]

\hat{T}_{xy}=T(p) (21)

Then, the provisional point set mₜ{i, j} in the rotational coordinate system Σ_{S} is calculated as follows.

[Formula 22]

m_{t{i,j}}=X(θⱼ)\hat{T}_{xy}m_{S{i,j}} (22)

Next, this mₜ(i, j) is fitted into the reference sphere, and its center coordinates (cx, cy, cz) are used to determine ρ_{z} and τ_{z} as follows.

[Formula 23]

\hat{ρ}_{z}=−atan 2(c_{y},cₓ)

\hat{τ}_{z}=−c_{z} (23)

Note that atan 2 is a function that represents the 4-quadrant inverse conjugate and is defined as follows.

$$\begin{matrix}[ Formula 24 ] & \\ atan 2 ( y , x ) = \{ \begin{matrix}arctan ( y / x ) if x > 0 \\ arctan ( y / x ) + π if x < 0 \\ undefined if x = 0\end{matrix} & ( 24 )\end{matrix}$$

Then, Tz is defined as follows.

$$\begin{matrix}[ Formula 25 ] & \\ {\hat{T}}_{z} = [ \begin{matrix}cos {\hat{ρ}}_{z} & - sin {\hat{ρ}}_{z} & 0 & 0 \\ sin {\hat{ρ}}_{z} & cos {\hat{ρ}}_{z} & 0 & 0 \\ 0 & 0 & 1 & {\hat{τ}}_{z} \\ 0 & 0 & 0 & 1\end{matrix} ] & ( 25 )\end{matrix}$$

Consequently, with respect to the fixed-axis coordinate system Σ_{AX}, which is set in such a manner that the X_{AX} axis passes through the reference sphere at θ=0, the position and posture of the line laser sensor (surface measuring sensor) are determined as follows.

[Formula 26]

\hat{T}=\hat{T}_{z}\hat{T}_{xy} (26)

That is, the transformed sensor data is represented as follows in the rotational coordinate system Σ_{RV}.

[Formula 27]

\hat{m}_{t{i,j}}=X(θⱼ)\hat{T}m_{s{i,j}} (27)

The following effects can be expected according to this second exemplary embodiment.

In a shape measuring apparatus including a rotary table (rotary mechanism), the sensor position and posture relative to the rotational coordinate system Σ_{RV} of the rotary table (rotary mechanism) can be accurately identified. This enables high-accuracy measurements using the rotary table.

When a high-accuracy sensor (for example, a line laser sensor) is attached to a robot to perform measurements, the absolute positioning accuracy of a positioning device, such as a robot, is insufficient, and the measurement accuracy has been limited by the positioning accuracy of the robot. On the other hand, the positioning repeatability of a robot is often higher than its absolute positioning accuracy. Therefore, if the position and posture of a sensor attached to the hand of a robot (sensor position and posture) can be identified by some method, it will enable measurements at that position and posture with high precision. Accordingly, a rotary table for scanning a workpiece is introduced to determine the position and posture of a sensor, and the coordinate system of the rotary table is used as the reference for measurement. In this case, the robot functions as a transport system that places the sensor in a predetermined position and posture, and the rotary table handles the measurement reference and scanning. By identifying the position and posture of the sensor relative to the rotary table using this method, it is possible to achieve high-accuracy measurements in a system, which includes a sensor, a robot, and a rotary table, utilizing the rotary table and the sensor.

Note that the disclosure is not limited to the above embodiments and can be appropriately modified without departing from the gist.

The probe used to detect the surface of an object to be measured is not limited to a contact-type probe, but may be a non-contact-type probe. A non-contact-type probe includes an optical type and a capacitive type, and an optical-type probe includes a confocal chromatic sensor and a laser reflection type, but is not limited thereto. In addition, a contact-type probe is not limited to those described in the above embodiments. Regardless of whether the probe is contact or non-contact, there are various configurations regarding the shape of the probe (stylus), the support mode for the probe (stylus), and the displacement detection method for the probe (stylus), and the probe configuration is not limited. Depending on the probe configuration, calibration targets, such as the sensitivity of detectors (gain parameters), the assembly posture of components such as a probe (stylus) (assembly posture parameters), and the shape of components such as a probe (stylus) (shape parameters), and the like, are appropriately set.

Although a roundness measuring apparatus is used in the above description as an example of a shape measuring apparatus, the disclosure is not limited thereto and can be applied to measuring apparatuses that use a cylindrical coordinate system and includes a rotary mechanism. Depending on the terminology used in the field of an object to be measured, a measuring apparatus that uses a cylindrical coordinate system can also be referred to as a cylindrical measuring apparatus, a gear measuring apparatus, an aspheric lens measuring apparatus, or a free-form surface measuring apparatus.

The calibration method described in the above embodiments can be widely applied to measuring apparatuses including a rotary mechanism, and the shape measuring apparatus to be calibrated should not be limited to the roundness measuring apparatus in the above embodiments.

In the second exemplary embodiment, an articulated robot is described as the sensor holding mechanism. However, the sensor holding mechanism may simply be a support column that does not have joints or actuators. In other words, a sensor (a surface measuring sensor or a line laser sensor) may be fixedly installed on the support column.

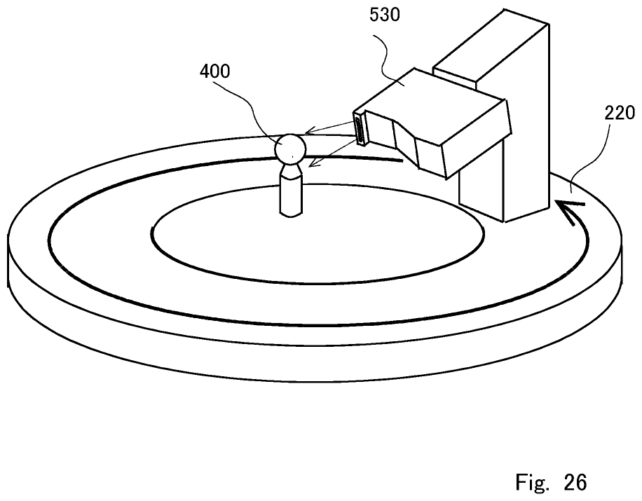

In the above embodiments, an example is described in which a workpiece is placed on a rotary table and the workpiece is rotationally moved. However, as shown in FIG. 26, the sensor (surface measuring sensor or line laser sensor) 530 may be configured to rotate around the workpiece (400) by the rotary mechanism (200).

In the second exemplary embodiment, a line laser sensor is described as the surface measuring sensor 530. However, the surface measuring sensor may be either a contact-type sensor or a non-contact-type sensor. For example, a scanning probe serves as a contact-type sensor. As the surface measuring sensor, it suffices if it includes a two-dimensional or three-dimensional scale or sensor internally and can perform scanning measurement within a certain range of a workpiece in a single measurement operation (or series of measurement operations).

With regard to the above embodiments, the following supplemental notes are disclosed.

### (Supplemental Note 1)

A shape measuring apparatus comprising:
a measuring unit configured to measure at least one point on a surface of an object to be measured;
a workpiece holding stage configured to hold the object to be measured; and
a rotary mechanism configured to rotate the workpiece holding stage relative to the measuring unit about a predetermined axis as a rotation center axis to rotationally move the measuring unit relative to the object to be measured, wherein
the shape measuring apparatus is configured to perform:
a calibration data acquisition step of acquiring calibration measurement data by the measuring unit measuring a calibration jig with a known shape while the rotary mechanism rotates the measuring unit relative to the calibration jig; and
a calibration calculation step of calibrating the shape measuring apparatus in such a manner that the calibration measurement data acquired in the calibration data acquisition step approximates the known shape of the calibration jig.

### (Supplemental Note 2)

The shape measuring apparatus according to Supplemental Note 1, wherein
the measuring unit is a coordinate measuring unit configured to perform a coordinate measurement of the surface of the object to be measured using a measuring head, the measuring head configured to detect the surface of the object to be measured,
the calibration jig has a spherical portion with a known diameter,
the calibration data acquisition step includes acquiring the calibration measurement data by the measuring head measuring the spherical portion while the rotary mechanism rotates the measuring head relative to the calibration jig, and
the calibration calculation step includes fitting the calibration measurement data acquired in the calibration data acquisition step to a spherical equation to calibrate the shape measuring apparatus in such a manner that a fitted sphere obtained by fitting the calibration measurement data to the spherical equation approximates the spherical portion of the calibration jig.

### (Supplemental Note 3)

The shape measuring apparatus according to Supplemental Note 2, wherein
an axis parallel to a rotation axis of the rotary mechanism is defined as a Z-axis,
an axis perpendicular to the rotation axis of the rotary mechanism is defined as an X-axis, and
the calibration data acquisition step includes measuring the spherical portion while the rotary mechanism moves a position of the measuring head in an X-axis direction in order for the measuring head to measure the calibration jig, and rotates the measuring head relative to the calibration jig.

### (Supplemental Note 4)

The shape measuring apparatus according to Supplemental Note 2 or 3, wherein the calibration calculation step includes calibrating an origin offset parameter in such a manner that an origin of a measurement coordinate system of the shape measuring apparatus is aligned with the rotation center axis of the rotary mechanism.

### (Supplemental Note 5)

The shape measuring apparatus according to any one of Supplemental Notes 2 to 4, wherein a parameter to be calibrated in the calibration calculation step includes a geometric parameter of the measuring head.

### (Supplemental Note 6)

The shape measuring apparatus according to any one of Supplemental Notes 2 to 5, wherein the calibration jig is intentionally placed on the workpiece holding stage in such a manner that a center of the spherical portion of the calibration jig is slightly shifted from the rotation center axis of the rotary mechanism.

### (Supplemental Note 7)

The shape measuring apparatus according to Supplemental Note 6, wherein a parameter to be calibrated in the calibration calculation step includes a gain coefficient of the coordinate measuring unit.

### (Supplemental Note 8)

The shape measuring apparatus according to any one of Supplemental Notes 2 to 7, wherein
an axis parallel to a rotation axis of the rotary mechanism is defined as a Z-axis,
an axis perpendicular to the rotation axis of the rotary mechanism is defined as an X-axis, and
a detection point shift, where a point at which the measuring head detects the surface of the object to be measured is shifted in a direction along the X-axis and in a direction intersecting with the X-axis, is calibrated.

### (Supplemental Note 9)

The shape measuring apparatus according to Supplemental Note 1, wherein
the measuring unit is a surface measuring sensor configured to measure at least two points on the surface of the object to be measured in a single measurement operation to obtain coordinate values in sensor coordinates,
the shape measuring apparatus is configured to further perform a sensor position/posture temporary setting step of temporarily setting a position and a posture of the surface measuring sensor relative to the rotary mechanism, and
the calibration calculation step includes determining, based on the temporarily set position and posture of the surface measuring sensor and a rotation angle of the rotary mechanism, three-dimensional shape data of the calibration jig derived from the calibration measurement data acquired in the calibration data acquisition step to calibrate the relative position and relative posture of the surface measuring sensor in such a manner that the determined three-dimensional shape data of the calibration jig approximates the known shape of the calibration jig.

### (Supplemental Note 10)

The shape measuring apparatus according to Supplemental Note 9, wherein the surface measuring sensor is a sensor configured to detect the surface of the object to be measured in one, two, or three dimensions.

### (Supplemental Note 11)

The shape measuring apparatus according to Supplemental Note 9 or 10, wherein the calibration jig has a shape with known dimensions or has a perfect spherical portion.

### (Supplemental Note 12)

The shape measuring apparatus according to any one of Supplemental Notes 9 to 11, wherein the calibration jig is intentionally placed on the workpiece holding stage so as to be shifted from the rotation center axis of the rotary mechanism.

### (Supplemental Note 13)

The shape measuring apparatus as according to any one of Supplemental Notes 9 to 12, further comprising:
a sensor holding mechanism configured to maintain the position and the posture of the surface measuring sensor relative to the rotary mechanism.

### (Supplemental Note 14)

The shape measuring apparatus according to Supplemental Note 13, wherein the sensor holding mechanism is an articulated robot.

### (Supplemental Note 15)

A calibration method for a shape measuring apparatus, the shape measuring apparatus comprising:
a measuring unit configured to measure at least one point on a surface of an object to be measured;
a workpiece holding stage configured to hold the object to be measured; and
a rotary mechanism configured to rotate the workpiece holding stage relative to the measuring unit about a predetermined axis as a rotation center axis to rotationally move the measuring unit relative to the object to be measured, the calibration method comprising:
a calibration data acquisition step of acquiring calibration measurement data by the measuring unit measuring a calibration jig with a known shape while the rotary mechanism rotates the measuring unit relative to the calibration jig; and
a calibration calculation step of calibrating the shape measuring apparatus in such a manner that the calibration measurement data acquired in the calibration data acquisition step approximates the known shape of the calibration jig.

### (Supplemental Note 16)

A calibration program for a shape measuring apparatus, the shape measuring apparatus incorporating a computer and comprising:
a measuring unit configured to measure at least one point on a surface of an object to be measured;
a workpiece holding stage configured to hold the object to be measured; and
a rotary mechanism configured to rotate the workpiece holding stage relative to the measuring unit about a predetermined axis as a rotation center axis to rotationally move the measuring unit relative to the object to be measured, the calibration program causing the computer to execute:
a calibration data acquisition step of acquiring calibration measurement data by the measuring unit measuring a calibration jig with a known shape while the rotary mechanism rotates the measuring unit relative to the calibration jig; and
a calibration calculation step of calibrating the shape measuring apparatus in such a manner that the calibration measurement data acquired in the calibration data acquisition step approximates the known shape of the calibration jig.
100 Roundness measuring apparatus
110 Host computer
112 Monitor
120 Operation unit
130 Motion controller
200 Measuring machine main body
210 Base
220 Rotary table
221 Rotary drive unit
222 Adjustment knob
223 Stage
300 Coordinate measuring unit
310 Z-axis column
320 Z-slider
330 X-arm
340 Head holder
350 Probe (measuring head)
360 Stylus
361 Stylus arm part
362 Stylus edge part
363 Contact point
370 Probe body part
371 Tilt angle detector
400 Calibration jig
410 Mount part
420 Reference sphere
500 Shape measuring apparatus
501 Measuring machine main body
510 Coordinate measuring unit
520 Articulated robot
530 Surface measuring sensor

1. A shape measuring apparatus comprising:
a measuring unit configured to measure at least one point on a surface of an object to be measured;
a workpiece holding stage configured to hold the object to be measured; and
a rotary mechanism configured to rotate the workpiece holding stage relative to the measuring unit about a predetermined axis as a rotation center axis to rotationally move the measuring unit relative to the object to be measured, wherein
the shape measuring apparatus is configured to perform:
a calibration data acquisition step of acquiring calibration measurement data by the measuring unit measuring a calibration jig with a known shape while the rotary mechanism rotates the measuring unit relative to the calibration jig; and
a calibration calculation step of calibrating the shape measuring apparatus in such a manner that the calibration measurement data acquired in the calibration data acquisition step approximates the known shape of the calibration jig.

2. The shape measuring apparatus according to claim 1, wherein
the measuring unit is a coordinate measuring unit configured to perform a coordinate measurement of the surface of the object to be measured using a measuring head, the measuring head configured to detect the surface of the object to be measured,
the calibration jig has a spherical portion with a known diameter,
the calibration data acquisition step includes acquiring the calibration measurement data by the measuring head measuring the spherical portion while the rotary mechanism rotates the measuring head relative to the calibration jig, and
the calibration calculation step includes fitting the calibration measurement data acquired in the calibration data acquisition step to a spherical equation to calibrate the shape measuring apparatus in such a manner that a fitted sphere obtained by fitting the calibration measurement data to the spherical equation approximates the spherical portion of the calibration jig.

3. The shape measuring apparatus according to claim 2, wherein
an axis parallel to a rotation axis of the rotary mechanism is defined as a Z-axis,
an axis perpendicular to the rotation axis of the rotary mechanism is defined as an X-axis, and
the calibration data acquisition step includes measuring the spherical portion while the rotary mechanism moves a position of the measuring head in an X-axis direction in order for the measuring head to measure the calibration jig, and rotates the measuring head relative to the calibration jig.

4. The shape measuring apparatus according to claim 2, wherein the calibration calculation step includes calibrating an origin offset parameter in such a manner that an origin of a measurement coordinate system of the shape measuring apparatus is aligned with the rotation center axis of the rotary mechanism.

5. The shape measuring apparatus according to claim 2, wherein a parameter to be calibrated in the calibration calculation step includes a geometric parameter of the measuring head.

6. The shape measuring apparatus according to claim 2, wherein the calibration jig is intentionally placed on the workpiece holding stage in such a manner that a center of the spherical portion of the calibration jig is slightly shifted from the rotation center axis of the rotary mechanism.

7. The shape measuring apparatus according to claim 6, wherein a parameter to be calibrated in the calibration calculation step includes a gain coefficient of the coordinate measuring unit.

8. The shape measuring apparatus according to claim 2, wherein
an axis parallel to a rotation axis of the rotary mechanism is defined as a Z-axis,
an axis perpendicular to the rotation axis of the rotary mechanism is defined as an X-axis, and
a detection point shift, where a point at which the measuring head detects the surface of the object to be measured is shifted in a direction along the X-axis and in a direction intersecting with the X-axis, is calibrated.

9. The shape measuring apparatus according to claim 1, wherein
the measuring unit is a surface measuring sensor configured to measure at least two points on the surface of the object to be measured in a single measurement operation to obtain coordinate values in sensor coordinates,
the shape measuring apparatus is configured to further perform a sensor position/posture temporary setting step of temporarily setting a position and a posture of the surface measuring sensor relative to the rotary mechanism, and
the calibration calculation step includes determining, based on the temporarily set position and posture of the surface measuring sensor and a rotation angle of the rotary mechanism, three-dimensional shape data of the calibration jig derived from the calibration measurement data acquired in the calibration data acquisition step to calibrate the relative position and relative posture of the surface measuring sensor in such a manner that the determined three-dimensional shape data of the calibration jig approximates the known shape of the calibration jig.

10. The shape measuring apparatus according to claim 9, wherein the surface measuring sensor is a sensor configured to detect the surface of the object to be measured in one, two, or three dimensions.

11. The shape measuring apparatus according to claim 9, wherein the calibration jig has a shape with known dimensions or has a perfect spherical portion.

12. The shape measuring apparatus according to claim 9, wherein the calibration jig is intentionally placed on the workpiece holding stage so as to be shifted from the rotation center axis of the rotary mechanism.

13. The shape measuring apparatus as according to claim 9, further comprising:
a sensor holding mechanism configured to maintain the position and the posture of the surface measuring sensor relative to the rotary mechanism.

14. The shape measuring apparatus according to claim 13, wherein the sensor holding mechanism is an articulated robot.

15. A calibration method for a shape measuring apparatus, the shape measuring apparatus comprising:
a measuring unit configured to measure at least one point on a surface of an object to be measured;
a workpiece holding stage configured to hold the object to be measured; and
a rotary mechanism configured to rotate the workpiece holding stage relative to the measuring unit about a predetermined axis as a rotation center axis to rotationally move the measuring unit relative to the object to be measured, the calibration method comprising:
a calibration data acquisition step of acquiring calibration measurement data by the measuring unit measuring a calibration jig with a known shape while the rotary mechanism rotates the measuring unit relative to the calibration jig; and
a calibration calculation step of calibrating the shape measuring apparatus in such a manner that the calibration measurement data acquired in the calibration data acquisition step approximates the known shape of the calibration jig.

16. A calibration program for a shape measuring apparatus, the shape measuring apparatus incorporating a computer and comprising:
a measuring unit configured to measure at least one point on a surface of an object to be measured;
a workpiece holding stage configured to hold the object to be measured; and
a rotary mechanism configured to rotate the workpiece holding stage relative to the measuring unit about a predetermined axis as a rotation center axis to rotationally move the measuring unit relative to the object to be measured, the calibration program causing the computer to execute:
a calibration data acquisition step of acquiring calibration measurement data by the measuring unit measuring a calibration jig with a known shape while the rotary mechanism rotates the measuring unit relative to the calibration jig; and
a calibration calculation step of calibrating the shape measuring apparatus in such a manner that the calibration measurement data acquired in the calibration data acquisition step approximates the known shape of the calibration jig.
